(19) United States
(12) Patent Application Publication
(10) Pub. No.: US 2026/0057276 A1
(43) Pub. Date: Feb. 26, 2026

(54) SELECTIVE TRAINING OF CLASSICAL AND QUANTUM MODELS

(71) Applicant: International Business Machines Corporation, Armonk, NY (US)

(72) Inventors: Laura Elise Schleeper, Amsterdam (NL); Brian Leo Quanz, Yorktown Heights, NY (US); Ginés Carrascal de las Heras, Getafe (ES); Das Pemmaraju, Stockton, CA (US); Chee-Kong Lee, Tacoma, WA (US); Daniel Joseph Fry, Bucuresti (RO); Amol Arvind Deshmukh, New York, NY (US); Jae-Eun Park, Wappingers Falls, NY (US)

(21) Appl. No.: 18/782,865

(22) Filed: Jul. 24, 2024

(30) Foreign Application Priority Data
May 24, 2024 (EP) 24382556.9

(51) Int. Cl. G06N 10/60

(52) U.S. Cl. CPC G06N 10/60

(57) ABSTRACT

One or more systems, devices, computer program products and/or computer-implemented methods of use provided herein relate to identifying training data for quantum machine learning models. A system can comprise a processor that can execute computer executable components stored in memory, wherein the computer executable components can comprise a training component that can employ a training dataset to train a hybrid machine learning model to generate predictions, wherein training the hybrid machine learning model can comprise assigning, via a combination model, respective first weights to a first subset of training data comprised in the training dataset, assigning, via the combination model, respective second weights to a second subset of the training data, training the at least one classical machine learning model based on the first subset of the training data, and training the at least one quantum machine learning model based on the second subset of the training data.

### BACKGROUND

The subject disclosure relates to hybrid machine learning techniques, and, more specifically, to selective training of classical machine learning models and quantum machine learning models.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable selective training of classical machine learning models and quantum machine learning models are discussed.

According to an embodiment, a system is provided. The system can comprise a memory that can store computer executable components. The system can further comprise a processor that can execute the computer executable components stored in the memory, wherein the computer executable components can comprise a training component that can train, by employing a training dataset, a hybrid machine learning model to generate predictions, wherein the hybrid machine learning model can comprise at least one classical machine learning model and at least one quantum machine learning model, and wherein training the hybrid machine learning model can comprise assigning, by employing a combination model, respective first weights to a first subset of training data selected from the training dataset based upon a defined classical weighting criterion. The training the hybrid machine learning model can further comprise assigning, by employing the combination model, respective second weights to a second subset of training data selected from the training dataset based upon a defined quantum weighting criterion. The training the hybrid machine learning model can further comprise training the at least one classical machine learning model by employing first training data selected from the first subset of the training data based on the respective first weights and a defined classical selection criterion. The training the hybrid machine learning model can further comprise training the at least one quantum machine learning model, via one or more quantum processors, by employing second training data selected from the second subset of the training data based on the respective second weights and a defined quantum selection criterion.

According to various embodiments, the above-described system can be implemented as a computer-implemented method or as a computer program product.

### BRIEF DESCRIPTION OF THE DRAWINGS

One or more embodiments are described below in the Detailed Description section with reference to the following drawings:

FIG. 1 illustrates a block diagram of an example, non-limiting system that can perform selective training of classical machine learning models and quantum machine learning models in accordance with one or more embodiments described herein.

FIG. 2 illustrates another block diagram of an example, non-limiting system that can perform selective training of classical machine learning models and quantum machine learning models in accordance with one or more embodiments described herein.

FIG. 3 illustrates a flow diagram of an example, non-limiting method that can perform selective training of classical machine learning models and quantum machine learning models in accordance with one or more embodiments described herein.

FIG. 4 illustrates a flow diagram of an example, non-limiting method that can perform selective training of classical machine learning models and quantum machine learning models by employing an error-based technique in accordance with one or more embodiments described herein.

FIG. 5 illustrates another flow diagram of an example, non-limiting method that can perform selective training of classical machine learning models and quantum machine learning models by employing an error-based technique in accordance with one or more embodiments described herein.

FIG. 6 illustrates a flow diagram of an example, non-limiting method that can perform selective training of classical machine learning models and quantum machine learning models by employing an iterative technique in accordance with one or more embodiments described herein.

FIG. 7 illustrates a flow diagram of an example, non-limiting method that can perform selective training of classical machine learning models and quantum machine learning models by employing an error clustering technique in accordance with one or more embodiments described herein.

FIG. 8 illustrates a flow diagram of an example, non-limiting method that can perform selective training of classical machine learning models and quantum machine learning models by employing a cluster-first technique in accordance with one or more embodiments described herein.

FIG. 9 illustrates a flow diagram of an example, non-limiting method that can perform selective training of classical machine learning models and quantum machine learning models by employing a partition optimization technique in accordance with one or more embodiments described herein.

FIG. 10A illustrates a flow diagram of an example, non-limiting method that can perform selective training of classical machine learning models and quantum machine learning models in accordance with one or more embodiments described herein.

FIG. 10B illustrates another flow diagram of an example, non-limiting method that can perform selective training of classical machine learning models and quantum machine learning models in accordance with one or more embodiments described herein.

FIG. 11 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

According to an embodiment, a system is provided. The system can comprise a memory that can store computer executable components. The system can further comprise a processor that can execute the computer executable components stored in the memory, where the computer executable components can comprise a training component that can train, by employing a training dataset, a hybrid machine learning model to generate predictions, where the hybrid machine learning model can comprise at least one classical machine learning model and at least one quantum machine learning model, and where training the hybrid machine learning model can comprise assigning, by employing a combination model, respective first weights to a first subset of training data selected from the training dataset based upon a defined classical weighting criterion. The training the hybrid machine learning model can further comprise assigning, by employing the combination model, respective second weights to a second subset of training data selected from the training dataset based upon a defined quantum weighting criterion. The training the hybrid machine learning model can further comprise training the at least one classical machine learning model by employing first training data selected from the first subset of the training data based on the respective first weights and a defined classical selection criterion. The training the hybrid machine learning model can further comprise training the at least one quantum machine learning model, via one or more quantum processors, by employing second training data selected from the second subset of the training data based on the respective second weights and a defined quantum selection criterion.

Such embodiments of the system can provide a number of advantages, including improving the performance of the hybrid machine learning model to generate the predictions and reducing the training duration involved in training the hybrid machine learning model. By directing the classical and quantum machine learning models to different subsets of the training dataset, the system can also scale to larger datasets.

In one or more embodiments of the aforementioned system, the combination model can combine respective predictions generated by the at least one classical machine learning model and the at least one quantum machine learning model to generate a final prediction.

Such embodiments of the system can provide the advantage of generating a prediction with improved accuracy, for example, as opposed to generating a final prediction based on training the classical machine learning model and the quantum machine learning model on the entire training dataset.

In one or more embodiments of the aforementioned system, the training the hybrid machine learning model can further comprise training the at least one classical machine learning model on a training set comprised in the training dataset, training the combination model on a validation set comprised in the training dataset by employing error labels based on erroneous predictions generated by the at least one classical machine learning model based on the validation set comprised in the training dataset, predicting, by employing the combination model, error probabilities indicative of the at least one classical machine learning model generating new erroneous predictions based on the training set comprised in the training dataset, selecting, by employing the combination model, the respective first weights and the respective second weights based on the error probabilities, and combining, by employing the combination model, respective predictions generated by the at least one classical machine learning model and the at least one quantum machine learning model based on a different validation set comprised in the training dataset and a test set, after the training of the hybrid machine learning model.

Such embodiments of the system can provide a number of advantages, including further improving the performance of the hybrid machine learning model, reducing the training duration involved in the training, and preventing the combination model, classical machine learning model, and quantum machine learning model from overfitting on the training data.

In one or more embodiments of the aforementioned system, the training the hybrid machine learning model can further comprise iteratively updating, by employing the combination model, the respective first weights and the respective second weights based on respective accuracies of the respective predictions, and retraining the at least one classical machine learning model and the at least one quantum machine learning model based on the updating.

Such embodiments of the system can provide a number of advantages, including further improving the performance of the hybrid machine learning model, reducing the training duration involved in the training, preventing the combination model, classical machine learning model, and quantum machine learning model from overfitting on the training data, and identifying training data that can be common to both the classical machine learning model, and the quantum machine learning model.

In one or more embodiments of the aforementioned system, the training the hybrid machine learning model can further comprise training the at least one classical machine learning model on a training set comprised in the training dataset, training the combination model on a validation set comprised in the training dataset by employing error labels based on erroneous predictions generated by the at least one classical machine learning model based on the validation set comprised in the training dataset, predicting, by employing the combination model, error probabilities indicative of the at least one classical machine learning model generating new erroneous predictions based on the training set comprised in the training dataset, grouping, by employing the combination model, samples from the training set associated with the new erroneous predictions into at least one cluster, and training the at least one quantum machine learning model based on the at least one cluster.

Such embodiments of the system can provide a number of advantages, including further improving the performance of the hybrid machine learning model, reducing the training duration involved in the training, and preventing the combination model, classical machine learning model, and quantum machine learning model from overfitting on the training data.

In one or more embodiments of the aforementioned system, the training the hybrid machine learning model can further comprise partitioning the training dataset into two or more clusters, training the at least one classical machine learning model and the at least one quantum machine learning model on the two or more clusters, generating, by employing the at least one classical machine learning model, respective first predictions on respective clusters of the two or more clusters, generating, by employing the at least one quantum machine learning model, respective second predictions on the respective clusters of the two or more clusters, assigning respective first clusters of the two or more clusters to the at least one classical machine learning model based on the respective first predictions, and assigning respective second clusters of the two or more clusters to the at least one quantum machine learning model based on the respective second predictions.

Such embodiments of the system can provide a number of advantages, including further improving the performance of the hybrid machine learning model, reducing the training duration involved in the training, and preventing the combination model, classical machine learning model, and quantum machine learning model from overfitting on the training data.

In one or more embodiments of the aforementioned system, the training the hybrid machine learning model can further comprise generating a first optimized quantum complexity score for the first subset of the training data, generating a second optimized quantum complexity score for the second subset of the training data, selecting the respective first weights according to the first optimized quantum complexity score, selecting the respective second weights according to the second optimized quantum complexity score, and training the combination model to predict new weights for respective predictions generated by the at least one classical machine learning model and the at least one quantum machine learning model on data.

Such embodiments of the system can provide a number of advantages, including further improving the performance of the hybrid machine learning model, reducing the training duration involved in the training, and preventing the combination model, classical machine learning model, and quantum machine learning model from overfitting on the training data.

In one or more embodiments of the aforementioned system, the respective first weights and the respective second weights can be selected to minimize errors in respective predictions generated by the at least one classical machine learning model and the at least one quantum machine learning model to improve performance of the hybrid machine learning model.

Such embodiments of the system can provide a number of advantages, including further improving the performance of the hybrid machine learning model, reducing the training duration involved in the training, and improving the training accuracy of the classical machine learning model and the quantum machine learning model.

In one or more embodiments of the aforementioned system, the respective first weights and the respective second weights can be assigned to samples comprised in the training dataset or to features of the samples comprised in the training dataset.

Such embodiments of the system can provide a more nuanced approach to train the hybrid machine learning model.

Additionally or alternatively, training the hybrid machine learning model to generate predictions, where the hybrid machine learning model can comprise at least one classical machine learning model and at least one quantum machine learning model, in conjunction with iteratively updating, by employing the combination model, the respective first weights and the respective second weights based on respective accuracies of the respective predictions, and retraining the at least one classical machine learning model and the at least one quantum machine learning model based on the iterative updating can more accurately identify the training data that can be applied to train the classical machine learning model and the quantum machine learning model. For example, in some embodiments, some training data can be common to both the classical machine learning model and the quantum machine learning model, and training each model on such training data can ensure that different information or data patterns that can be generated by the classical machine learning model and the quantum machine learning model on the same data are captured more efficiently.

The embodiments disclosed in the present disclosure can be applied to predictive tasks such as, for example, predicting certain trends for businesses, predicting class outputs, etc. based on data arising from real-world scenarios. For example, the hybrid machine learning model can be trained for specific prediction tasks, wherein the training can comprise assigning respective first weights to a first subset of training data comprised in the training dataset, assigning respective second weights to a second subset of the training data comprised in the training dataset, training a set of classical machine learning models comprised in the hybrid machine learning model on the first subset of the training data and training a set of quantum machine learning models comprised in the hybrid machine learning model on the second subset of the training data. After training, hybrid machine learning model can be deployed to generate predictions based on real-world data. The training of the hybrid machine learning model can result in the classical machine learning model and the quantum machine learning model generating respective predictions and capturing different trends on the real-world data that can be combined by the combination model as a final prediction generated by the hybrid machine learning model.

According to various embodiments, the above-described system can be implemented as a computer-implemented method or as a computer program product.

Machine learning is often applied to predictive tasks for classification. For example, many practical use cases of machine learning can define such predictive tasks and employ datasets comprising numerical measurements to predict a class given the numerical measurements. For example, businesses employ machine learning to predict if a transaction is faulty, or to predict if a customer is likely to leave a service provided by the business, and so on. Quantum machine learning employs quantum computing in the machine learning process to generate such predictions. While quantum machine learning can be combined with classical computing in different ways, the advantage of employing quantum machine learning models is to extract a different interpretation of input data as compared to classical machine learning models. Thus, quantum machine learning models are often employed in predictive tasks to capture different patterns in the input data than those captured by classical machine learning models. The ability of a quantum machine learning model to capture the different patterns can be attributed to the inductive bias of the quantum machine learning model, wherein the inductive bias can match the data that the quantum machine learning model is applied to. Thus, if the inductive bias results in a good match to the data, it can indicate that the quantum machine learning model is specialized or is able to model the patterns in the data efficiently.

In practice, whether a quantum machine learning model is a better match to a dataset than a classical machine learning model is not known beforehand. Unless the inductive biases of quantum machine learning models are a good match to the data comprised in a dataset, applying the quantum machine learning models to the dataset may not provide any benefits. Existing techniques that employ quantum machine learning typically rely on trial-and-error techniques by applying quantum machine learning models to a dataset without knowledge of whether the inductive biases of quantum machine learning models are a good match to the dataset. For example, many existing techniques apply quantum machine learning to entire datasets while tuning quantum machine learning models to make them more applicable to the datasets with the goal of generating better results than classical machine learning. In some cases, the results generated by quantum machine learning model can be compared to results generated by a classical machine learning model, both classical and quantum models can be trained on entire datasets and their predictions combined to determine if the averaging can generate better results, or the predictions of classical and quantum models can be combined in different ways. However, quantum machine learning models often do not work better than classical machine learning models when applied to entire classical datasets arising from practical use cases, and the performance improvements, if any, are negligible. Further, existing techniques cannot determine whether a quantum machine learning model or classical machine learning model can be suitably applied to an entire dataset comprising some patterns/data that can be better learnt by quantum machine learning models and other patterns/data that can be better learnt by classical machine learning models, and defining different subsets in training data to train quantum and classical machine learning models on the specific data points most applicable to either models can be challenging.

Embodiments described herein include systems, computer-implemented methods, and computer program products that can perform selective training of classical machine learning models and quantum machine learning models on different subsets of data comprised in a training dataset, such that the quantum machine learning models can capture different patterns from the intrinsic training data than those captured by the classical machine learning models. In various embodiments, a training component can employ a training dataset to train a hybrid machine learning model to generate predictions. The hybrid machine learning model can comprise at least one classical machine learning model, at least one quantum machine learning model, and a combination model. To train the hybrid machine learning model, the training component can train the classical machine learning model and the quantum machine learning model on different portions of the training dataset. For example, the training component can employ the combination model to assign respective first weights to a first subset of training data selected from the training dataset based upon a defined classical weighting criterion, and the training component can employ first training data selected from the first subset of the training data based on the respective first weights and a defined classical selection criterion to train the classical machine learning model.

Similarly, the training component can employ the combination model to assign respective second weights to a second subset of training data selected from the training dataset based upon a defined quantum weighting criterion, and the training component can employ second training data selected from the second subset of the training data based on the respective second weights and a defined quantum selection criterion to train the quantum machine learning model. In various embodiments, the training component can employ one or more quantum processors to train the quantum machine learning model. In various embodiments, the respective first weights and the respective second weights can be selected by the combination model to minimize errors in respective predictions generated by the classical machine learning model and the quantum machine learning model to improve performance of the hybrid machine learning model. In various embodiments, the training component can train the combination model to combine respective predictions generated by the classical machine learning model and the quantum machine learning model to generate a final prediction. By assigning different respective weights to the first subset of the training data and the second subset of the training data, the combination model can identify information patterns comprised in the training dataset that can be more applicable to train the classical machine learning model and information patterns comprised in the training dataset that can be more applicable to train the quantum machine learning model.

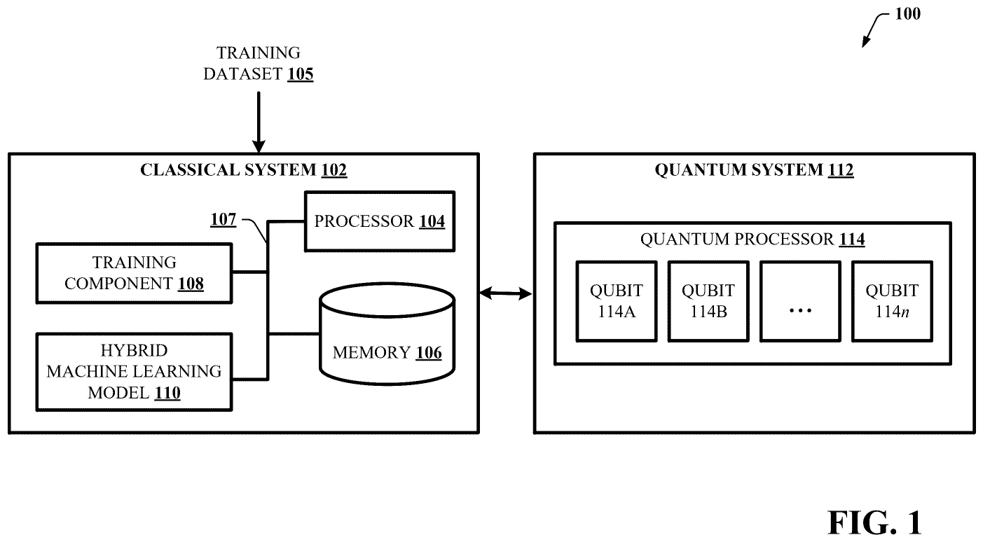

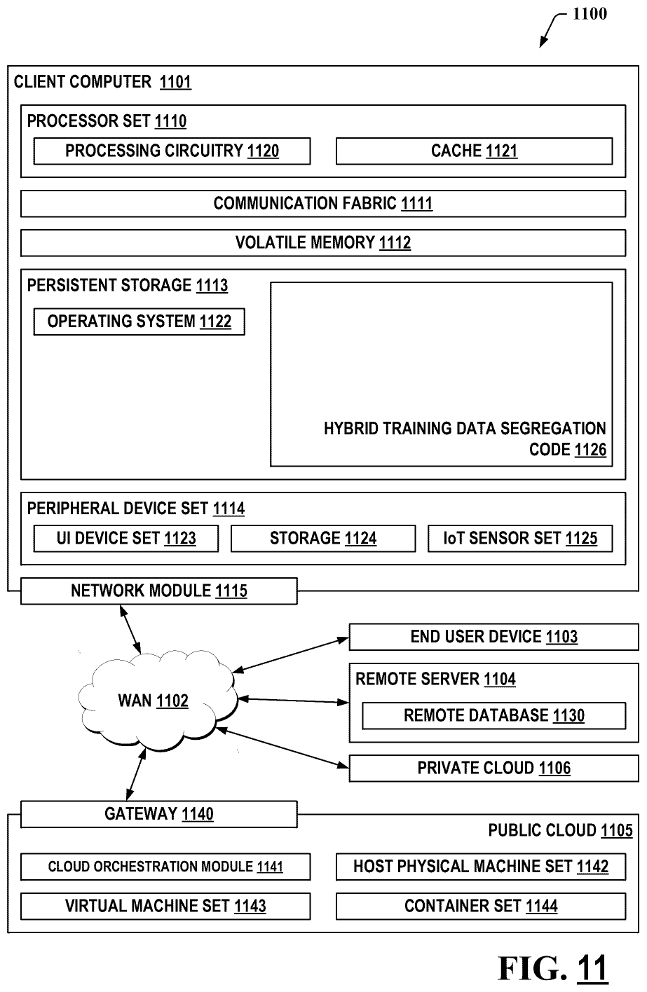

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1100 illustrated at FIG. 11. For example, non-limiting system 100 can be associated with, such as accessible via, a computing environment 1100 described below with reference to FIG. 11, such that aspects of processing can be distributed between non-limiting system 100 and the computing environment 1100. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates a block diagram of an example, non-limiting system 100 that can perform selective training of classical machine learning models and quantum machine learning models in accordance with one or more embodiments described herein.

As illustrated in FIG. 1, non-limiting system 100 can comprise classical system 102 and quantum system 112. Classical system 112 can be coupled to quantum system 112. Quantum system 112 can comprise at least one quantum processor, such as quantum processor 114. Classical system 102 can comprise one or more components, such as a memory 106, processor 104, bus 107, training component 108 and/or hybrid machine learning model 110. In some embodiments, training component 108 can be comprised at least partially by quantum system 112. Quantum processor 114 can comprise a quantum logic circuit comprising one or more qubits, such as qubit 114A, qubit 114B, . . . , qubit 114n, etc. Quantum processor 114 can be any suitable processor. Quantum processor 114 can generate one or more instructions for controlling the quantum logic circuit.

Non-limiting system 100 and/or components of non-limiting system 100 can be employed to use hardware and/or software to solve problems that are highly technical in nature (e.g., related to quantum computing, quantum machine learning models, etc.), that are not abstract and that cannot be performed as a set of mental acts by a human. Further, some of the processes performed may be performed by specialized computers for carrying out defined tasks related to quantum computing. Non-limiting system 100 and/or components of non-limiting system 100 can be employed to solve new problems that arise through advancements in technologies mentioned above and/or the like. Non-limiting system 100 can provide technical improvements to machine learning systems by eliminating noisy training data from training datasets employed to train quantum machine learning models and classical machine learning models, optimizing test error and generalization error during the training, prevent the quantum and classical machine learning models from overfitting on the training data, and reducing the training time. Non-limiting system 100 can improve individual performance efficiencies of the trained quantum and classical machine learning models as well as the collective performance efficiency of a hybrid machine learning model comprising the quantum and classical machine learning models.

Discussion turns briefly to processor 104, memory 106 and bus 107 of non-limiting system 100. For example, in one or more embodiments, the non-limiting system 100 can comprise processor 104 (e.g., computer processing unit, microprocessor, classical processor, and/or like processor). In one or more embodiments, a component associated with non-limiting system 100, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, non-limiting system 100 can comprise a computer-readable memory (e.g., memory 106) that can be operably connected to processor 104. Memory 106 can store computer-executable instructions that, upon execution by processor 104, can cause processor 104 and/or one or more other components of non-limiting system 100 (e.g., training component 108, hybrid machine learning model 110, combination model 202, classical machine learning model 204, quantum machine learning model 206, weights assignment component 302 and/or combination rule component 304) to perform one or more actions. In one or more embodiments, memory 106 can store computer-executable components (e.g., training component 108, hybrid machine learning model 110, combination model 202, classical machine learning model 204, quantum machine learning model 206, weights assignment component 302 and/or combination rule component 304).

Non-limiting system 100 and/or a component thereof as described herein, can be communicatively, electrically, operatively, optically and/or otherwise coupled to one another via bus 107. Bus 107 can comprise one or more of a memory bus, memory controller, peripheral bus, external bus, local bus, and/or another type of bus that can employ one or more bus architectures. One or more of these examples of bus 107 can be employed. In one or more embodiments, non-limiting system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of non-limiting system 100 can reside in the cloud, and/or can reside locally in a local computing environment (e.g., at a specified location(s)).

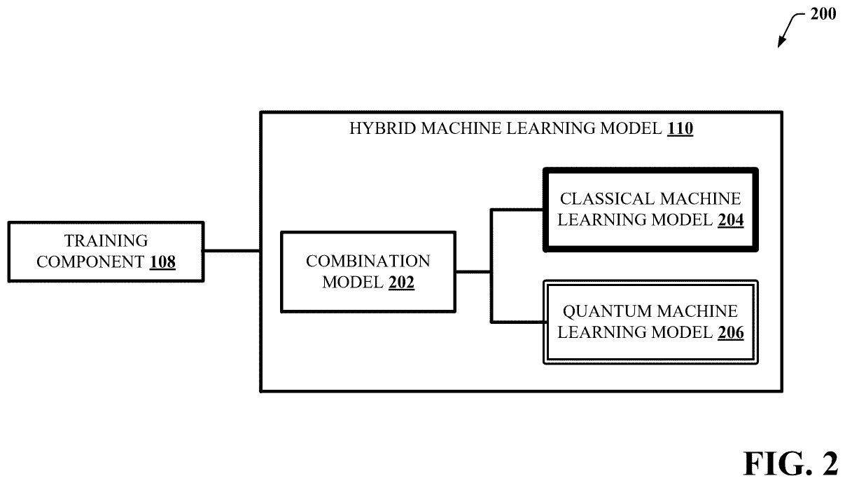

In various embodiments, training component 108 can employ training dataset 105 to train a hybrid machine learning model 110 to generate predictions. Hybrid machine learning model 110 can comprise at least one classical machine learning model, at least one quantum machine learning model, and a combination model. For example, as illustrated by non-limiting system 200 of FIG. 2, hybrid machine learning model 110 can comprise classical machine learning model 204, quantum machine learning model 206, and combination model 202. In this regard, non-limiting system 200 illustrates the system of training component 108 and hybrid machine learning model 110. In some embodiments, hybrid machine learning model 110 can comprise additional classical machine learning models and quantum machine learning models.

To train hybrid machine learning model 110, training component 108 can train classical machine learning model 204 and quantum machine learning model 206 on different portions of training dataset 105. For example, in various embodiments, training component 108 can employ combination model 202 to assign respective first weights to a first subset of training data selected from training dataset 105 based upon a defined classical weighting criterion, and training component 108 can employ first training data selected from the first subset of the training data based on the respective first weights and a defined classical selection criterion to train classical machine learning model 204. Similarly, training component 108 can employ combination model 202 to assign respective second weights to a second subset of training data selected from training dataset 105 based upon a defined quantum weighting criterion, and training component 108 can employ second training data selected from the second subset of the training data based on the respective second weights and a defined quantum selection criterion to train quantum machine learning model 206. In various embodiments, training component 108 can employ one or more quantum processors, such as quantum processor 114 comprised in quantum system 112, to train quantum machine learning model 206. In various embodiments, the respective first weights and the respective second weights can be selected by combination model 202 to minimize errors in respective predictions generated by classical machine learning model 204 and quantum machine learning model 206 to improve performance of hybrid machine learning model 110.

In an embodiment, selecting the first training data from the first subset of the training data can imply assigning higher or lower weights to certain samples or directing classical machine learning model 204 to focus on some samples more than other samples comprised in training dataset 105. This can be achieved by identifying the parameters of classical machine learning model 204 that can optimize (e.g., minimize) the loss function of classical machine learning model 204 and optimizing the loss function based on the samples since different samples can contribute smaller or larger multipliers in the loss function based on their weighting. As a result, the parameters of classical machine learning model 204 can fit, for example, lower weighted samples better or have a smaller loss on the lower weighted samples than higher weighted samples. Similarly, in an embodiments, selecting the second training data from the second subset of the training data can imply assigning higher or lower weights to certain samples or directing quantum machine learning model 206 to focus on some samples more than other samples comprised in training dataset 105. For example, training component 108 can identify the parameters of quantum machine learning model 206 that can optimize (e.g., maximize) the loss function of quantum machine learning model 206 and, optimizing the loss function such that the parameters of quantum machine learning model 206 can fit, for example, higher weighted samples better or have a smaller loss on the higher weighted samples than the lower weighted samples.

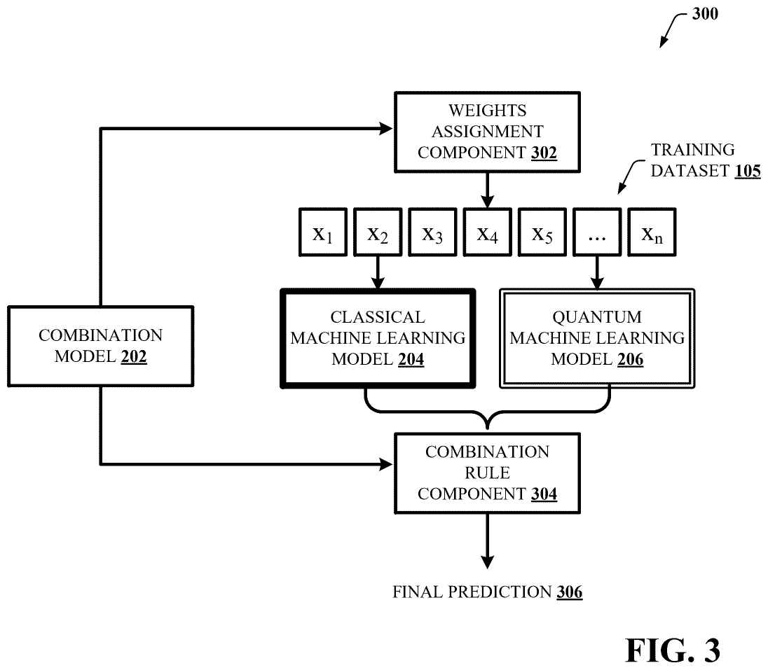

In various embodiments, training component 108 can train combination model 202 to combine respective predictions generated by classical machine learning model 204 and quantum machine learning model 206 to generate a final prediction. Combination model 202 can employ a weights assignment component 302 (FIG. 3) to assign weights to samples in training dataset 105 and employ combination rule component 304 (FIG. 3) to combine the respective predictions generated by classical machine learning model 204 and quantum machine learning model 206 to generate the final prediction. In this regard, weights assignment component 302 and combination rule component 304 can be sub-components of combination model 202. Additionally, combination rule component 304 can define different combination rules for different embodiments to combine the respective predictions of classical machine learning model 204 and quantum machine learning model 206.

By assigning different respective weights to the first subset of the training data and the second subset of the training data, combination model 202 can identify first information patterns comprised in training dataset 105 that can be more applicable to train classical machine learning model 204 and second information patterns comprised in training dataset 105 that can be more applicable to train quantum machine learning model 206. Training classical machine learning model 204 and quantum machine learning model 206 on different respective information patterns can improve the performance of hybrid machine learning model 110 by improving respective performances of classical machine learning model 204 and quantum machine learning model 206, as compared to the performance of hybrid machine learning model 110 resulting from training classical machine learning model 204 and quantum machine learning model 206 on the entirety of training dataset 105. That is because training data that can be more suitable to train classical machine learning model 204 can be processed as noise by quantum machine learning model 206 and training data that can be more suitable to train quantum machine learning model 206 can be processed as noise by classical machine learning model 204. In other words, the types of patterns in the training data that the quantum machine learning model(s) of hybrid machine learning model 110 can be more suitable to model, can be different from the types of patterns in the training data that the classical machine learning model(s) of hybrid machine learning model 110 can be more suitable to model. Accordingly, the quantum machine learning model(s) and classical machine learning model(s) can be better at generalizing, that is, making accurate predictions on unseen data, if the models are focused on respectively appropriate data subsets or distributions. This is due to the inductive bias inherent in each model type (i.e., quantum models and classical models).

In various embodiments, combination model 202 can employ different defined classical weighting criteria to assign the respective first weights to the first subset of the training data and different defined quantum weighting criteria to assign the respective second weights to the second subset of the training data. Similarly, training component 108 can employ different defined classical selection criteria to train classical machine learning model 204 according to the respective first weights and different defined quantum selection criteria to train quantum machine learning model 206 according to the respective second weights. The defined classical weighting criteria, defined quantum weighting criteria, defined classical selection criteria and defined quantum selection criteria can be selected according to an error-based technique, an iterative technique, an error clustering technique, a cluster-first technique or a partition optimization technique described infra. In various embodiments, holdout sets can be employed to fit/train combination model 202, classical machine learning model 204 and quantum machine learning model 206, which can optimize test error and generalization error in each case. The holdout sets can be employed in conjunction with out-of-sample training of the respective machine learning models to prevent the respective machine learning models from overfitting on training data comprised in the holdout sets. In general, combination model 202 can define portions of training dataset 105 that can be more suitable to train quantum machine learning model 206 versus classical machine learning model 204. In practice applications, such embodiments can ensure that complex information patterns comprised in a dataset that can be challenging for classical machine learning model 204 to process can be processed by quantum machine learning model 206.

Early experiments conducted for the embodiments disclosed herein on three different datasets have shown promising results and performance improvements, and an improved performance has been obtained for the error-based technique described below for some datasets. For example, hybrid machine learning model 110 comprising quantum machine learning model 206 and classical machine learning model 204 as base models with each model focused on different parts of training dataset 105, and further comprising combination model 202 (an additional classical machine learning model) that can weight the predictions of each base model to generate final predictions, resulted in consistent improvements in prediction accuracy metric scores compared to the best single quantum and classical models belonging the same classes as the base models. In particular, for experiments conducted on two public datasets for customer churn prediction and an experiment conducted for customer purchase propensity, hybrid machine learning model 110 scored one to five percentage points higher than the best individual model across multiple different test sets and multiple different sizes of training sets, for the majority of the training sets. Further, hybrid machine learning model 110 scored similar to the best individual model on another training size and across a third dataset. Additionally, hybrid machine learning model 110 consistently performed significantly better than an existing common ensembling approach known as stacking. Stacking combines the predictions of the base models, with each of the base models trained on the entire training set, unlike the embodiments disclosed herein that can automatically focus the training of each individual model (e.g., classical machine learning model 204, quantum machine learning model 206, etc.) on the portions of the training data most suitable for the model via the various approaches disclosed herein.

Contrary to embodiments of the present disclosure, common ensembling techniques like boosting (including Adaboost, XGBoost, and others) and Random Forest do not employ any additional predictive models besides the base models, and these along with other ensembling approaches do not employ out-of-sample predictions for additional weighting and training of component models. Such ensembling techniques also do involve techniques to automatically focus the training of different base models on different subsets or sub-distributions of training data to capitalize on the significantly different inductive biases of the base models (e.g., quantum machine learning models and classical machine learning models). Embodiments of the present disclosure can harness the idea that inductive biases (a property) of quantum machine learning models are significantly different than the inductive biases of classical machine learning models. Additionally, embodiments of the present disclosure also propose techniques to extract the benefits of quantum machine learning models for arbitrary data by focusing quantum machine learning models and classical machine learning models on portions of training data that can be most applicable to either model, as opposed to some existing techniques that are focused on determining whether an entire dataset is suitable for either quantum machine learning modeling or classical machine learning modeling. Thus, the techniques disclosed herein provide unique advantages over existing technologies.

### Error-Based Technique:

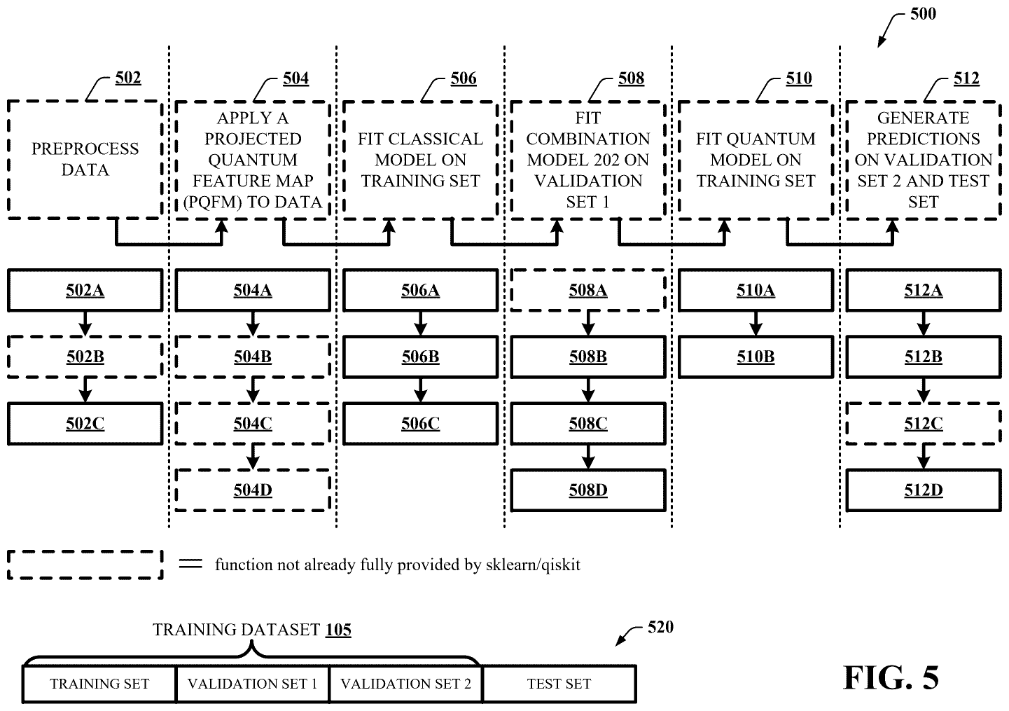

In an embodiment, training component 108 can employ an error-based technique to train classical machine learning model 204 and quantum machine learning model 206, wherein the portions of training dataset 105 that can be more applicable to train quantum machine learning model 206 can be defined by error probabilities of predictions generated by classical machine learning model 204. For example, training component 108 can partition training dataset 105 into a training set, validation set 1, validation set 2 to train hybrid machine learning model 110. The data splits of training dataset 105 are also illustrated in FIG. 5. Training component 108 can further employ a test set to train the hybrid machine learning model 110. For example, training component 108 can train classical machine learning model 204 on the training set. Thereafter, training component 108 can employ classical machine learning model 204 to generate predictions based on validation set 1, and training component 108 can train combination model 202 on validation set 2 by employing error labels based on erroneous predictions comprised in the predictions generated by classical machine learning model 204 based on validation set 1. In the various embodiments herein, erroneous predictions can refer to prediction having accuracies less than a defined accuracy threshold.

After training combination model 202, training component 108 can employ combination model 202 to predict error probabilities associated with classical machine learning model 204, which error probabilities can indicate the likelihood of classical machine learning model 204 generating new erroneous predictions based on the training set. For example, combination model 202 can predict respective error probabilities for respective samples comprised in the training set, wherein an error probability for a sample can define a probability that classical machine learning model 204 will generate an erroneous prediction for that sample. In this embodiment, combination model 202 can act as an error model or error predictor model, and combination model 202 can select the respective first weights and the respective second weights based on the predicted error probabilities (e.g., defined classical weighting criterion and defined quantum weighting criterion). For example, combination model 202 can select respective error probabilities for the respective samples as the respect second weights for the respective samples in the training set. Accordingly, training component 108 can train quantum machine learning model 206 on the samples in the training set. As such, a threshold value can be defined for the performance of combination model 202, and combination model 202 can employ the threshold value to select error probabilities as described supra.

In an implementation, combination model 202 can select the inverse values of the respective second weights as the respective first weights (e.g., defined classical weighting criterion) and assign the respective first weights to the respective samples comprised in the training set. Accordingly, training component 108 can retrain classical machine learning model 204 by employing the samples comprised in the training set. As such, combination model 202 can assign higher weights to samples that can be more suitable to train quantum machine learning model 206 and assign lower weight to samples that can be more suitable to train classical machine learning model 204. Samples with higher weights can put more weight on the loss function of quantum machine learning model 206 during training, and quantum machine learning model 206 can be trained on the higher weighted samples.

Finally, training component 108 can employ classical machine learning model 204 and quantum machine learning model 206 to generate predictions on validation set 1 and the test set, and combination model 202 can combine respective predictions generated by classical machine learning model 204 and quantum machine learning model 206 based on the respective first weights and the respective second weights. For example, combination model 202 can predict new respective error probabilities for respective samples comprised in validation set 2 to identify samples for which classical machine learning model 204 can be expected to generate erroneous predictions. Based on the new error probabilities, combination model 202 can weigh and combine the respective predictions generated by classical machine learning model 204 and quantum machine learning model 206 for a new sample. For example, if a new error probability of classical machine learning model 204 predicted by combination model 202 for the new sample is higher than a defined value, combination model 202 can assign more weight to the prediction generated by quantum machine learning model 206 and less weight to the prediction generated by classical machine learning model 204 to generate a final prediction.

As further explanation for the error-based technique, the weights assigned to samples in a training set selected from training dataset 105 can be employed to train quantum machine learning model 206 to generate predictions. For example, classical machine learning model 204 can be directly trained on the training set, and classical machine learning model 204 can be employed to generate predictions on validation set 1 (the first holdout set). Next, combination model 202 can be trained to predict the error probabilities of classical machine learning model 204, based on erroneous predictions generated by classical machine learning model 204, for samples comprised in validation set 1. In other words, classical machine learning model 204 can be trained on validation set 1 and the erroneous predictions generated by classical machine learning model 204. Thereafter, the error probabilities predicted by combination model 202 can be employed as weights. The error probability for a sample can be a probability that classical machine learning model 204 will generate an erroneous prediction for the sample. The error probability for a sample in the training set can be employed as a weight for the sample, and each sample in the training set can be weighted according to the error probability predicted for that sample. After weighting the samples, quantum machine learning model 206 can be trained on the training set.

In an embodiment, classical machine learning model 204 can be retrained on the training set with the weights (1−error probability) assigned to each sample in training set. Thereafter, classical machine learning model 204 and quantum machine leaning model 206 can be applied to new samples. For example, classical machine learning model 204 can generate a prediction, C(x), equal to the probability of class 1 (e.g., a positive class) for a sample, x, quantum machine learning model 206 can generate a different prediction, Q(x), equal to the probability of class 1 for the sample, x, and combination model 202, E(x), can generate an error probability for the sample, x. Combination model 202 can be a trained classical machine learning model or a trained quantum machine learning model. Then, the final prediction generated by hybrid machine learning model 110 can be E(x)*Q(x)+ (1−E(x))*C(x). In various embodiments, an additional validation set (e.g., validation set of FIG. 5) can be employed to tune the process by employing different hyperparameters for each machine learning model comprised in hybrid machine learning model 110, or by tuning the hyperparameters for each machine learning model during the training of each machine learning model.

For a binary classification on new data, each base model (e.g., classical machine learning model 204 and quantum machine learning model 206) can output a probability, for example, of the positive class, and the final prediction of hybrid machine learning model 110 can be a combined prediction of the respective probabilities of the base models for the positive class. This concept can be extended to multiple classes, wherein each base model can output a vector of probabilities for each class. In some implementations, multiple models can be employed with such schemes as one-versus-one or one-versus-all models. For the case of regression, the base models can output continuous values, and combination model 202 can generate error probabilities greater than a defined threshold.

For example, the training set can comprise samples x1, x2, x3 and x4. In the error-based technique, combination model 202 can assign weights, w1, w2, w3 and w4 to samples x1, x2, x3 and x4, respectively, and training component 108 can train quantum machine learning model 206 on all four samples. However, the loss function employed to train quantum machine learning model 206 can be w1*Loss for x1+w2*Loss for x2+ . . . +w4*Loss for x4. As a result, quantum machine learning model 206 can more focused on certain samples than others during training. For example, if w4=5×w1, sample x4 can influence the training (and prediction) of quantum machine learning model 206, five times more than sample x1 can. If a weight assigned to a sample is zero, the sample can be excluded from training quantum machine learning model 206. The weightings assigned to samples comprised in the training set can be viewed as repetitions of a sample, such that new versions of training data comprised in training dataset 105 can be generated by training component 108 where samples are repeated/duplicated a number of times in proportion to their weights.

Thus, the erroneous predictions generated by classical machine learning model 204 can be employed to identify training data that can be applicable to train quantum machine learning model 206, since quantum machine learning models can capture patterns in the training data that can be different that those captured by classical machine learning models. As a result, quantum machine learning model 206 can be directed to portions of the training data that can be more accurately modeled by quantum machine learning model 206 than by classical machine learning model 204 (i.e., on training data that classical machine learning model 204 cannot generalize correctly when making predictions). If classical machine learning model 204 can generate highly accurate predictions for certain samples comprised in the training data, then quantum machine learning model 206 is unlikely to be more accurate or provide a better model for those samples. However, if classical machine learning model 204 is not a good fit for those samples, then quantum machine learning model 206 can be expected to be a good fit.

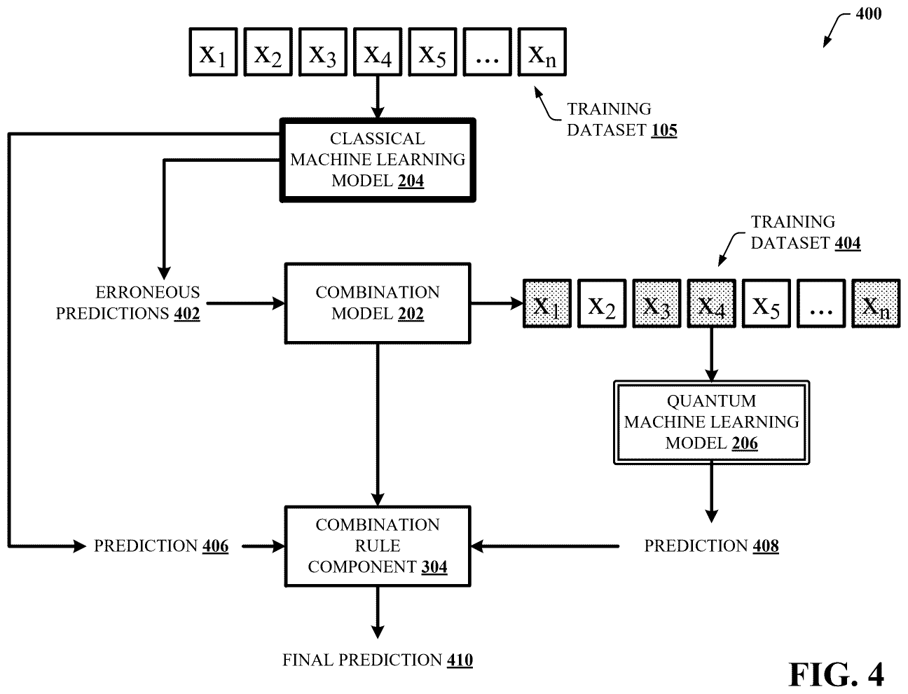

Thus, the error-based technique can employ the lack of generalizability of classical machine learning model 204 as the main criteria to direct the training of quantum machine learning model 206 on specific portions of training dataset 105. The techniques disclosed hereinafter include methods to further refine the portions or sub-distributions of the training data of training dataset 105 on which classical machine learning model 204 and quantum machine learning model 206 can be trained, by including training criteria in addition to the erroneous predictions generated by classical machine learning model 204. The error-based technique is discussed in greater detail infra with respect to FIGS. 4 and 5.

### Iterative Technique:

In another embodiment, training component 108 can employ an iterative technique to train classical machine learning model 204 and quantum machine learning model 206, wherein the portions of training dataset 105 that can be more applicable to train quantum machine learning model 206 can be defined by an iterative process. The iterative process can be an extension of the error-based technique. For example, training component 108 can train classical machine learning model 204 on samples from the training set with the respective first weights, and training component 108 can train quantum machine learning model 206 on samples from the training set with the respective second weights. After the training, training component 108 can employ classical machine learning model 204 and quantum machine learning model 206 to generate predictions on validation set 1, and combination model 202 can analyze accuracies of respective predictions generated by classical machine learning model 204 and quantum machine learning model 206 to update and reassign the respective first weights and the respective second weights. In some implementations, combination model 202 can update and reassign the respective first weights and the respective second weights based on more complex criteria instead of the respective predictions generated by classical machine learning model 204 and quantum machine learning model 206. In these embodiments, combination model 202 can be an iterative model, such as expectation maximization algorithm(s), the output of which can be employed to predict new weights for samples comprised in a dataset. For example, in an implementation, combination model 202 can assign higher respective second weights to samples on which quantum machine learning model 206 generates predictions with higher respective accuracies as compared to classical machine learning model 204. In another implementation, combination model 202 can assign the same respective first weights and respective second weights to samples on which both classical machine learning model 204 and quantum machine learning model 206 generate predictions with accuracies above a defined accuracy threshold. Thus, different defined quantum weighting criteria and defined classical weighting criteria can be applicable in different implementations of this embodiment.

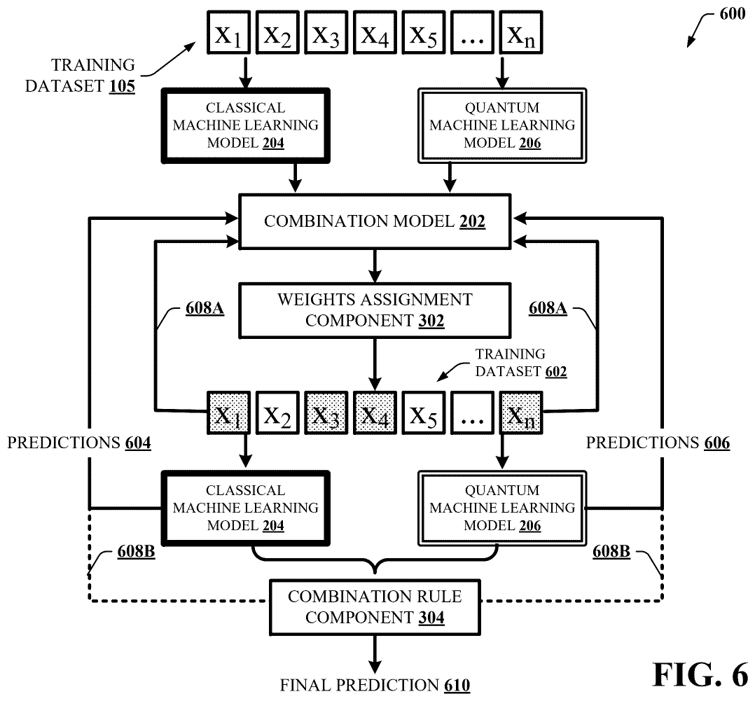

Classical machine learning model 204 and quantum machine learning model 206 can be retrained on the training set based on the updating and reassignment of the respective first weights and respective second weights, and the process can be repeated until convergence of combination model 202. For example, upon convergence, combination model 202 can assign the final respective first weights to first samples comprised in the training set and the final respective second weights to second samples comprised in the training set. Thereafter, training component 108 can retrain classical machine learning model 204 on the samples given the final respective first weights and train quantum machine learning model 206 on the samples given the final respective second weights. In an implementation, training component 108 can iteratively retrain classical machine learning model 204 and quantum machine learning model 206 after each cycle of the iterative process, and combination model 202 can combine the respective predictions generated by classical machine learning model 204 and quantum machine learning model 206 after the respective first weights and respective second weights converge to some specific values. During each iteration, retraining classical machine learning model 204 can generate a new classical machine learning model and retraining quantum machine learning model 206 can generate a new quantum machine learning model. The iterative technique is discussed in greater detail infra with respect to FIG. 6.

### Error Clustering Technique:

In yet another embodiment, training component 108 can employ an error clustering technique to train classical machine learning model 204 and quantum machine learning model 206, wherein the portions of training dataset 105 that can be more applicable to train quantum machine learning model 206 can be defined by clustering the training data corresponding to erroneous predictions generated by classical machine learning model 204. The error clustering technique can be similar to the error-based technique in some respects. For example, training component 108 can partition training dataset 105 into a training set, validation set 1, and validation set 2 to train hybrid machine learning model 110. Training component 108 can train classical machine learning model 204 on the training set. Thereafter, training component 108 can employ classical machine learning model 204 to generate predictions based on validation set 1, and training component 108 can employ error labels based on the erroneous predictions comprised in the predictions generated by classical machine learning model 204 to train combination model 202 on validation set 1. In this regard, training component 108 can train combination model 202 to learn the clustering of erroneous predictions generated by classical machine learning model 204. In various embodiments herein, erroneous predictions can refer to prediction having accuracies less than a defined accuracy threshold.

After training combination model 202, training component 108 can employ combination model 202 to predict error probabilities associated with classical machine learning model 204, which error probabilities can be indicative of classical machine learning model 204 generating new erroneous predictions based on the training set. For example, combination model 202 can predict respective error probabilities for respective samples comprised in the training set, wherein an error probability for a sample can define a probability of classical machine learning model 204 generating an erroneous prediction for that sample. Thereafter, combination model 202 can group samples from the training set associated with the new erroneous predictions into at least one cluster, and training component 108 can train quantum machine learning model 206 on the cluster. Based on the training, combination model 202 can employ classical machine learning model 204 or quantum machine learning model 206 to generate predictions for new samples. For example, a prediction for a new sample comprised in validation set 2 can be generated by classical machine learning model 204 if a distance of the new sample from the cluster is greater than the threshold value. Alternatively, a prediction for a new sample comprised in validation set 2 can be generated by quantum machine learning model 206 if the distance of the new sample from the cluster is less than the threshold value. In this regard, combination model 202 can be a distance-based error clustering model.

In an implementation, combination model 202 can group samples on which classical machine learning model 204 can be expected to generate correct predictions (i.e., predictions having accuracies greater than the defined accuracy threshold) into one or more first clusters (e.g., defined classical weighting criterion) and group samples associated with the new erroneous predictions into one or more second clusters (i.e., defined quantum weighting criterion). Training component 108 can retrain classical machine learning model 204 on the one or more first clusters and train quantum machine learning model 206 on the one or more second clusters, and based on the shortest distance of a new sample from the one or more first clusters or the one or more second clusters, a prediction associated with the new sample can be generated by classical machine learning model 204 or quantum machine learning model 206. For example, the prediction for the new sample can be generated by classical machine learning model 204 if the new sample is within a defined distance threshold from a cluster of the one or more first clusters, and the prediction for the new sample can be generated by quantum machine learning model 206 if the new sample is within the defined distance threshold from a cluster of the one or more second clusters.

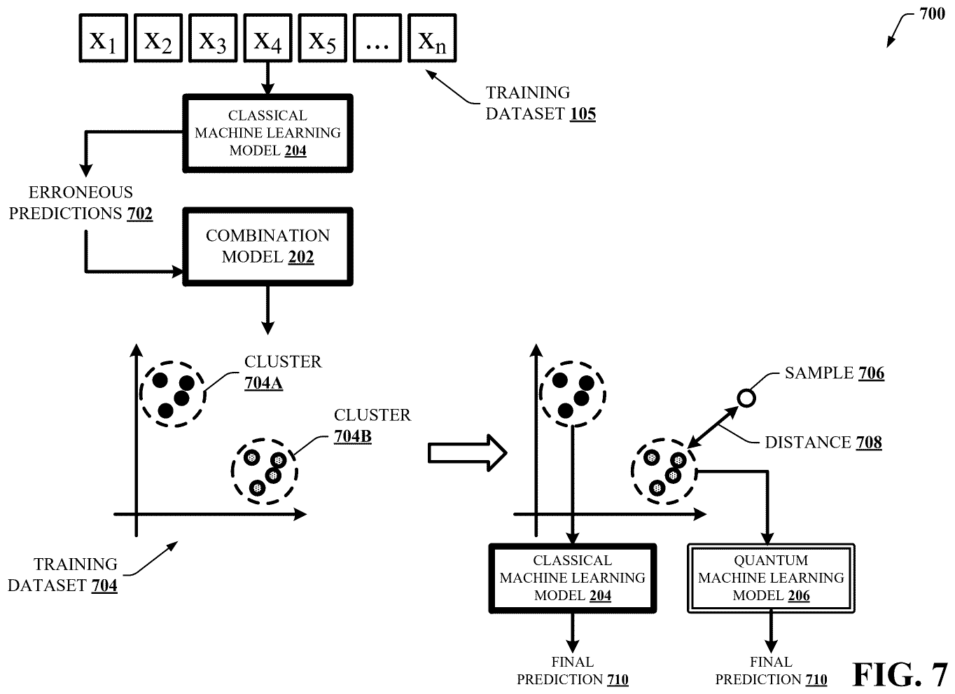

In this regard, combination model 202 can employ the defined distance threshold as a weight or decision, based on which, the prediction for the new sample can be generated by classical machine learning model 204 or quantum machine learning model 206. For example, respective distances of first new samples that lie within the defined distance threshold from a cluster of the one or more first clusters can be selected as the respective first weights applicable to the first new samples, and respective distances of second new samples that lie within the defined distance threshold from a cluster of the one or more second clusters can be selected as the respective second weights applicable to the second new samples. Further, a threshold radius value can be defined for the radii of the one or more first clusters and/or the one or more second clusters. The iterative technique is discussed in greater detail infra with respect to FIG. 7.

### Cluster-First Technique:

In yet another embodiment, training component 108 can employ a cluster-first technique to train classical machine learning model 204 and quantum machine learning model 206, wherein the portions of training dataset 105 that can be more applicable to train quantum machine learning model 206 can be defined by dividing training dataset 105 into clusters, prior to training classical machine learning model 204 and quantum machine learning model 206. Thereafter, classical machine learning model 204 and quantum machine learning model 206 can be trained on the clusters, and the performance of classical machine learning model 204 and quantum machine learning model 206 for respective clusters can be obtained. Finally, the clusters on which classical machine learning model 204 generates a performance above a defined performance threshold can be assigned to classical machine learning model 204, and the clusters on which quantum machine learning model 206 generates a performance above the defined performance threshold can be assigned to quantum machine learning model 206.

More specifically, training component 108 can partition training dataset 105 into two or more clusters, and training component 108 can train classical machine learning model 204 and quantum machine learning model 206 on each of the two or more clusters. Combination model 202 can analyze respective first predictions generated by classical machine learning model 204 based on respective clusters the two or more clusters, and combination model 202 can analyze respective second predictions generated by quantum machine learning model 206 based on respective clusters of the two or more clusters. Based on the analysis, combination model 202 can assign respective first clusters of the two or more clusters to classical machine learning model 204 and respective second clusters of the two or more clusters to quantum machine learning model 206. For example, the respective first clusters can comprise those clusters of the two or more clusters on which the performance of classical machine learning model 204 is greater than a defined performance threshold, and the respective second clusters can comprise those clusters of the two or more clusters on which the performance of quantum machine learning model 206 is greater than the defined performance threshold.

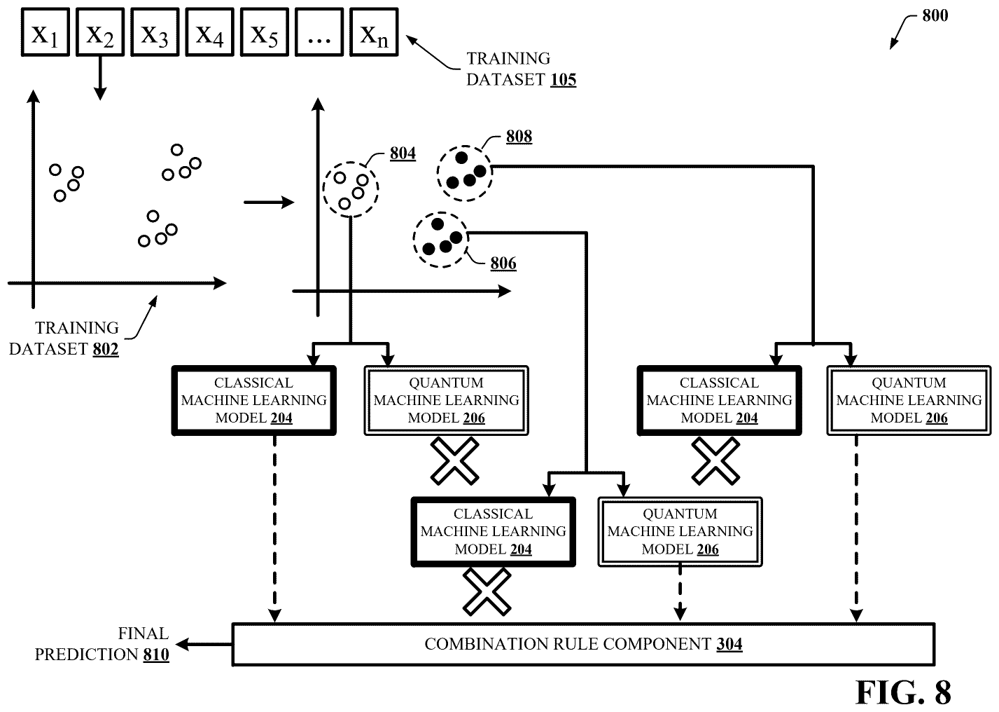

Based on the assignment of the respective first cluster and respective second clusters, training component 108 can employ classical machine learning model 204 to generate a prediction for a new sample if the new sample is within a defined distance from the respective first clusters and employ quantum machine learning model 206 to generate the prediction if the new sample is within the defined distance from the respective second clusters. In this regard, combination model 202 can employ the defined distance as a weight or decision, based on which, the prediction for the new sample can be generated by classical machine learning model 204 or quantum machine learning model 206. For example, respective distances of first new samples that lie within the defined distance from a cluster of the respective first clusters can be selected as the respective first weights applicable to the first new samples, and respective distances of second new samples that lie within the defined distance from a cluster of the respective second clusters can be selected as the respective second weights applicable to the second new samples. In an implementation, both classical machine learning model 204 and quantum machine learning model 206 can be employed to generate predictions for the new sample, and combination model 202 can combine the respective predictions of classical machine learning model 204 and quantum machine learning model 206 to generate a final prediction by assigning a higher weight to the prediction of the best performing machine learning model. The cluster-first technique is discussed in greater detail infra with respect to FIG. 8.

### Partition Optimization Technique:

In yet another embodiment, training component 108 can employ a partition optimization technique to train classical machine learning model 204 and quantum machine learning model 206, wherein the portions of training dataset 105 that can be more applicable to train quantum machine learning model 206 can be defined by a quantum complexity measure/score or another type of score. For example, training dataset 105 can be partitioned into the first subset of training data applicable to classical machine learning model 204 and the second subset of training data applicable to quantum machine learning model 206 by optimizing (i.e., minimizing or maximizing) quantum complexity scores for the partitioned subsets through an optimization process. In other words, samples comprised in training dataset 105 can be weighted based on the optimized quantum complexity score, and training dataset 105 can be partitioned into the first subset and the second subset of training data comprised in training dataset 105 such that the second subset can have the maximum quantum complexity score and the first subset can have the minimum quantum complexity score possible. Quantum complexity scores can be based on geometric differences, nearest neighbors, etc.

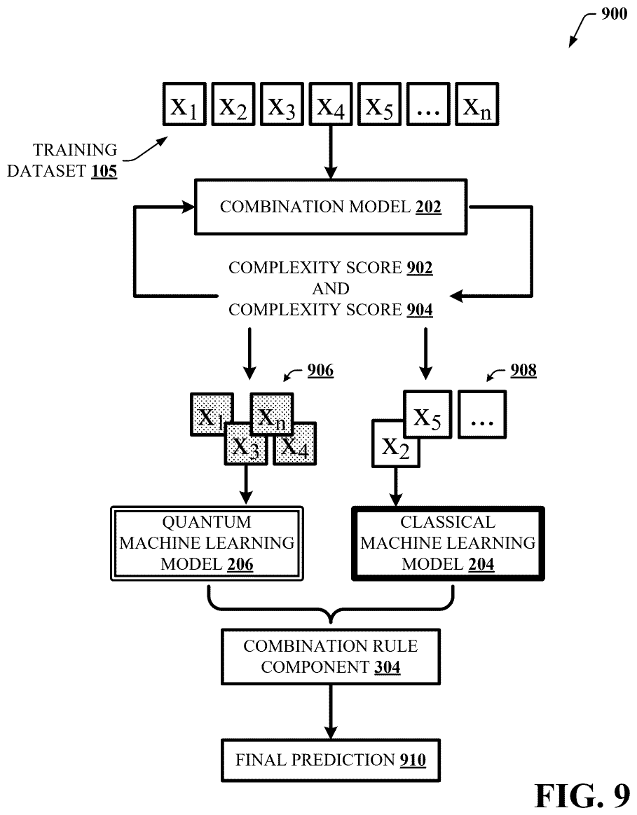

More specifically, combination model 202 can select a quantum complexity score to partition training dataset 105. Combination model 202 can generate a first optimized quantum complexity score for the first subset of the training data by minimizing or maximizing the quantum complexity score and a second optimized quantum complexity score for the second subset of the training data by minimizing or maximizing the quantum complexity score. Combination model 202 can select and assign the respective first weights to the first subset of the training data according to the first optimized quantum complexity score (e.g., defined classical weighting criterion) and the respective second weights to the second subset of the training data according to the second optimized quantum complexity score (e.g., defined quantum weighting criterion). Thereafter, training component 108 can train classical machine learning model 204 on the first subset of the training data and train quantum machine learning model 206 on the second subset of the training data, and classical machine learning model 204 and quantum machine learning model 206 can be employed to generate predictions on new data. Combination model 202 can combine the respective predictions generated by classical machine learning model 204 and quantum machine learning model 206 based on the first optimized quantum complexity score and the second optimized quantum complexity score. The partition optimization technique is discussed in greater detail infra with respect to FIG. 9.

In some embodiments, the above techniques can be employed with respect to feature dimensions of training dataset 105, as opposed to samples. For example, the techniques discussed supra refer to assigning weights to samples comprised in training dataset 105, wherein the samples can refer to data points or data distribution of training data comprised in training dataset 105. However, the same techniques can be applicable to feature dimensions of the sample, wherein a feature dimension represents a feature for a given sample or data point. That is, instead of identifying samples that can be more applicable to train classical machine learning model 204 and quantum machine learning model 206, embodiments of the present disclosure can identify features that can be more applicable to train classical machine learning model 204 and quantum machine learning model 206. For example, in some embodiments, classical machine learning techniques can be more suitably applied to a subset of features for the data point and quantum machine learning techniques can be more suitably applied to another subset of the features for the data point. Further, classical machine learning model 204 and quantum machine learning model 206 can be assigned different features. For example, classical machine learning model 204 and quantum machine learning model 206 can generate different respective predictions for different subsets of features for a data point, and the different respective predictions can be combined by combination model 202 to generate a final prediction for the data point.

More specifically, given a dataset of vectors xᵢ for i=1 to n, in some embodiments, the various techniques disclosed herein can be employed to assign weights, wⱼ, to individual features xᵢⱼ, across data points, instead of assigning sample weights sᵢ to each xᵢ. For example, assuming xᵢ as a vector with p entries described by xᵢⱼ for j=1 to p, a weight, wⱼ, can be assigned (e.g., by combination model 202) to each of the p features. This implies that quantum machine learning model 206 can be focused on or directed to some subspace as opposed to a subset or a sub-distribution of training data comprised in training dataset 105 (via different sample weights). For example, quantum machine learning model 206 can be trained on a subspace of features and classical machine learning model 204 can be trained on another subspace of the features. In some embodiments, quantum machine learning model 206 and classical machine learning model 204 can be trained on respectively different subsets of features.

FIG. 2 illustrates another block diagram of an example, non-limiting system 200 that can perform selective training of classical machine learning models and quantum machine learning models in accordance with one or more embodiments described herein. Repetitive description of like elements and/or processes employed in respective embodiments is omitted for sake of brevity.

Non-limiting system 200 illustrates the system of training component 108 and hybrid machine learning model 110. As described with reference to FIG. 1, training component 108 can train hybrid machine learning model 110 to generate predictions, wherein hybrid machine learning model 110 can comprise combination model 202, classical machine learning model 204 and quantum machine learning model 206. In some embodiments, hybrid machine learning model 110 can comprise additional classical machine learning models and/or quantum machine learning models. Further, combination model 202 can comprise weights assignment component 302 (FIG. 3) that combination model 202 can employ to assign weights to different samples/data points/feature vectors or feature dimensions/features of the samples/data points/feature vectors comprised in training dataset 105, and combination model 202 can comprise combination rule component 304 (FIG. 3) that combination model 202 can employ to combine respective predictions generated by classical machine learning model 204 and quantum machine learning model 206.

FIG. 3 illustrates a flow diagram of an example, non-limiting method 300 that can perform selective training of classical machine learning models and quantum machine learning models in accordance with one or more embodiments described herein. Repetitive description of like elements and/or processes employed in respective embodiments is omitted for sake of brevity.

With continued reference to FIGS. 1 and 2, non-limiting method 300 generally illustrates how training component 108 can train classical machine learning model 204 and quantum machine learning model 206 by employing training dataset 105 and combination model 202. The training of classical machine learning model 204 and quantum machine learning model 206 can employ any technique select from a group consisting of the error-based technique, iterative technique, error clustering technique, cluster-first technique or the partition optimization technique described supra. For example, elements x₁, x₂, x₃, x₄, x₅, . . . , xₙ can be different samples or different features of samples comprised in training dataset 105, some of which can be more applicable to train classical machine learning model 204 and some others of which can be more applicable to train quantum machine learning model 206. Training component 108 can employ combination model 202 to identify respective subsets of the elements comprised in training dataset 105 that can be employed to train classical machine learning model 204 and quantum machine learning model 206. For example, combination model 202 can employ weights assignment component 302 comprised in combination model 202 to assign respective first weights to a first subset of training data comprised in training dataset 105 based on a defined classical weighting criterion and respective second weights to a second subset of training data comprised in training dataset 105 based on a defined quantum weighting criterion. The respective first weights and respective second weights can identify the specific samples or features of training dataset 105 that classical machine learning model 204 and quantum machine learning model 206 can respectively focus on during training. Combination model 202 can further employ combination rule component 304 to define different combination rules (e.g., according to the error-based technique, iterative technique, error clustering technique, cluster-first technique or the partition optimization technique) to combine respective predictions generated by classical machine learning model 204 and quantum machine learning model 206 to generate final prediction 306. As such, combination model 202 can ensemble classical machine learning models with quantum machine learning models while improving the overall performance of hybrid machine learning model 110.

In practice, when new data is accessed by hybrid machine learning model 110, combination model 202 can decide whether a data point comprised in the new data is closer to the data distribution employed to train classical machine learning model 204 or to the data distribution employed to train quantum machine learning model 206. The decision can be a hard decision or soft decision. For example, in some embodiments, combination model 202 can decide that 70 percent (%) of the new data fits the training data distribution of quantum machine learning model 206 and 30% of the new data fits the training data distribution of classical machine learning model 204, and combination model 202 can assign respective portions of the new data to classical machine learning model 204 and quantum machine learning model 206 to generate the predictions. Further, combination model 202 can define different techniques to combine the predictions generated by classical machine learning model 204 and quantum machine learning model 206. For example, in some embodiments, combination model 202 can predict a probability that classical machine learning model 204 will generate an error on a data point, and the probabilities can be employed by combination rule component 304 to weight the respective predictions generated by classical machine learning model 204 and quantum machine learning model 206. Thus, final prediction 306 generated by combination rule component 304 can be defined by [(probability of error of classical machine learning model 204)×(prediction generated by quantum machine learning model 206)]+ [(1−probability of error of classical machine learning model 204)×prediction generated by classical machine learning model 204]. In such embodiments, combination model 202 can be another prediction model, and the output of combination model 202 can be employed in conjunction with some logic to generate final prediction 306 of hybrid machine learning model 110.

FIG. 4 illustrates a flow diagram of an example, non-limiting method 400 that can perform selective training of classical machine learning models and quantum machine learning models by employing an error-based technique in accordance with one or more embodiments described herein. Repetitive description of like elements and/or processes employed in respective embodiments is omitted for sake of brevity.

Non-limiting method 400 describes additional details about the error-based technique discussed with reference to FIG. 1 to train hybrid machine learning model 110. In various embodiments, combination model 202 can be a machine learning model, and combination model 202 can be an error model or an error predictor model that can predict a probability of classical machine learning model 204 generating an erroneous prediction for a sample comprised in a dataset. For example, a dataset can comprise some data that can be more applicable to train quantum machine learning model 206 or that can be noisy data for classical machine learning model 204. When employed to generated predictions on such a dataset, classical machine learning model 204 can fail to accurately capture the information patterns or generate erroneous predictions for the data that can be less favorable for classical machine learning model 204. In some situations, the erroneous predictions can result from intrinsic noise present in the data; however, in other situations, the data can comprise information that can be more accurately captured by quantum machine learning model 206. As a result, such data can be a potentially good candidate for quantum machine learning model 206 to generate different or more accurate predictions than those generated by classical machine learning model 204 and capture the information patterns that classical machine learning model 204 fails to capture. This idea can be further supported by the potential that the dataset can comprise other samples on which classical machine learning model 204 can generate correct/accurate predictions.

Under the assumption that classical machine learning model 204 can generate inaccurate predictions for some data comprised in a dataset, in various embodiments, training component 108 can train combination model 202 to identify the specific samples or features corresponding to such data and train quantum machine learning model 206 on the samples or features. To ensure sufficient training accuracy, non-limiting method 400 can employ the same dataset (e.g., training dataset 105) to validate combination model 202, classical machine learning model 204 and quantum machine learning model 206 as that employed to train the models, as opposed to employing a different dataset that is not reflective of the data distribution employed to train the models and that can cause hybrid machine learning model 110 to fail.

For example, in various embodiments, a holdout set can be employed to evaluate predictions generated by classical machine learning model 204 and identify erroneous predictions 402 generated by classical machine learning model 204. In some embodiments, the holdout set can be explicitly defined to achieve out-of-sample predictions of classical machine learning model 204. Holdout sets can refer to multiple subsets generated by dividing a large dataset. Out-of-sample predictions can refer to predictions generated by a model on a dataset that is different from the dataset employed for training the model. For example, training component 108 can partition training data set into a training set, validation set 1, and validation set 2 to train hybrid machine learning model 110. An additional test set can also be employed. Classical machine learning model 204 can be trained on the training set but applied to validation set 1 to generate predictions comprising both accurate predictions, and erroneous predictions 402. Validation set 1 can represent the holdout set, and the predictions generated by classical machine learning model 204 can be the out-of-sample predictions. Validation set 1 can be further employed in conjunction with error labels to train combination model 202.

In other embodiments, a cross-validation approach can be employed wherein training dataset 105 can be partitioned into multiple subsets, and classical machine learning model 204 can be trained on all but one subset and evaluated on the remaining subset. For example, training dataset 105 can be partitioned into five distinct holdout sets, classical machine learning model 204 can be trained on four out of the five distinct holdout sets, and classical machine learning model 204 can be evaluated on the holdout set not employed for the training. The process can be repeated five times, and a different holdout set can be reserved for evaluation of classical machine learning model 204 during each repetition, such that out-of-sample predictions of classical machine learning model 204 can be obtained on each of the five holdout sets without excluding any data from training dataset 105. In other words, the cross-validation approach can prevent the need to hold extra data aside due to the process being repeated for each holdout set.

As such, various techniques can be employed to generate out-of-sample sample predictions of classical machine learning model 204 to identify training data on which classical machine learning model 204 can generate erroneous predictions (i.e., erroneous predictions 402). The technique of employing multiple holdout sets (e.g., training set, validation set 1 and validation set 2) can be applied when enough training data is available, whereas the cross-validation approach can be employed to achieve the same results without sacrificing any data during training, if the training data is limited. With the cross-validation approach, combination model 202, classical machine learning model 204 and quantum machine learning model 206 can be trained on the full training data comprised in training dataset 105 while still generating out-of-sample predictions for each model. Validation set 2 and the test set can comprise new samples that can be applied to the trained machine learning models. However, to evaluate the techniques described herein, some data can be held out for testing due to the overall dataset being finite.

Combination model 202 can be trained by training component 108 by employing training data corresponding to erroneous predictions 402 and by employing error labels. For example, based on erroneous predictions 402, training component 108 can generate and assign labels to samples comprised in validation set 1 to distinguish samples on which classical machine learning model 204 generates accurate predictions from samples on which classical machine learning model 204 generates erroneous predictions 402. As a result, a new training dataset comprising the samples from validation set 1 with assigned labels can be generated, and combination model 202 can be tuned and trained on the new training dataset. Thus, training component 108 can train combination model 202 with an out-of-sample approach similar to that employed to train classical machine learning model 204 to prevent combination model 202 from overfitting on the new training dataset.

Thereafter, combination model 202 can be evaluated on the training set to obtain out-of-sample predictions. An out-of-sample prediction of combination model 202 for a sample can be an error probability indicating that classical machine learning model 204 can generate an erroneous prediction for that sample. The out-of-sample predictions of combination model 202 can be applied as weights to the samples in the training set, resulting in training dataset 404 comprising some samples with higher weights (e.g., x₂, x₅, etc.) than others (e.g., x₁, x₃, x₄, etc.). For example, combination model 202 can select and assign respective error probabilities predicted for respective samples as respective weights to the respective samples. Higher weighted samples can put more weight on the loss function of quantum machine learning model 206, causing quantum machine learning model 206 to focus on the higher weighted samples while ignoring lower weighted samples during training. As stated elsewhere herein, the embodiments in the present disclosure can be applicable to samples as well as features of samples.

In some embodiments, training component 108 can retrain classical machine learning model 204 by employing inverse values of the weights employed to train quantum machine learning model 206. For example, combination model 202 can assign a weight W to a sample to train quantum machine learning model 206 on the sample and assign a weight (1−W) to the same sample to train classical machine learning model 204 on the sample. After training combination model 202, classical machine learning model 204 and quantum machine learning model 206, training component 108 can employ hybrid machine learning model 110 to generate predictions on new data. For example, training component 108 can employ combination model 202 to predict the error probability of classical machine learning model 204 for a new sample, and classical machine learning model 204 and quantum machine learning model 206 can be employed to generate respective predictions for the new sample. The respective predictions can be probabilities of class outputs of each of classical machine learning model 204 and quantum machine learning model 206 for the new sample, and the respective predictions can be weighted according to the error probability. For example, prediction 408 of quantum machine learning model 206 can be weighted according to the error probability (e.g., 1) of the classical machine learning model 204, and prediction 406 of classical machine learning model 204 can be weighted with a weight of (1−E).

Combination model 202 can employ combination rule component 304 to combine the respective predictions of classical machine learning model 204 and quantum machine learning model 206 based on the weighting to generate final prediction 410. For example, for binary classifications, the base models or base predictor models (i.e., classical machine learning model 204 and quantum machine learning model 206) can generate respective probabilities of a positive class output and combination rule component 304 can combine the respective probabilities to generate a new probability. For example, combination model 202 can output a probability of about 0.9 that classical machine learning model 204 can generate an incorrect prediction on a new sample, and combination rule component 304 can apply a weight of 0.9 to prediction 408 of quantum machine learning model 206 and a weight of 0.1 (i.e., 1-0.9) to prediction 406 of classical machine learning model 204. In this example, prediction 408 can dominate final prediction 410 due to its higher weight. In various embodiments, final prediction 410 can also be a probability value. For example, if the output of quantum machine learning model 206 is 0.8 (e.g., a 0.8 probability that a new sample belongs to a positive class versus a negative class), and the output of classical machine learning model 204 is 0.1 for the positive class, then the 0.8 probability indicating that final prediction 410 can most likely belong to the positive class can dominate the 0.1 probability, because combination model 202 can assign a higher weight to the prediction of quantum machine learning model 206. In this example, final prediction 410 can be given by [(0.9×0.8)+ (0.9×0.1)]=0.81, indicating a probability of 0.81 of final prediction 410 belonging to the positive class.

On the contrary, if the error probability predicted by combination model 202 for a new sample is close to zero (0), indicating that classical machine learning model 204 is unlikely to generate an erroneous prediction for the new sample, then the combination rule component 304 can assign a higher weight to the prediction generated by classical machine learning model 204. If the error probability predicted by combination model 202 for the new sample is 0.5, then combination rule component 304 can assign equal weights to the respective predictions generated by classical machine learning model 204 and quantum machine learning model 206, and final prediction 410 can be equal to the average of the respective predictions.

FIG. 5 illustrates another flow diagram of an example, non-limiting method 500 that can perform selective training of classical machine learning models and quantum machine learning models by employing an error-based technique in accordance with one or more embodiments described herein. Repetitive description of like elements and/or processes employed in respective embodiments is omitted for sake of brevity.

Non-limiting method 500 illustrates the training pipeline of the error-based technique of non-limiting method 400 employed to train hybrid machine learning model 110. As described supra with reference to FIG. 4, training component 108 can split training dataset 105 into different holdout sets that can be employed as training and validation sets to obtain predictions for subsequent learning tasks. Training dataset 520 can illustrate the dataset resulting from splitting training dataset 105 into the different holdout sets. For example, training dataset 105 can be split into a training set, validation set 1, and validation set 2. A separate test set can be additionally employed as part of training dataset 520 to train hybrid machine learning model 110.

At each step in non-limiting method 500, training component 108 can internally tune the projected quantum feature map (PQFM), combination model 202, classical machine learning model 204 and quantum machine learning model 206 to ensure that the PQFM and the machine learning models have the correct settings and hyperparameters to perform well on the respective datasets employed. During training, the PQFM, combination model 202, classical machine learning model 204 and quantum machine learning model 206 can be fit on the respective datasets employed in the respective training steps, wherein fitting can imply fitting the parameters of the entity being trained (i.e., the PQFM, combination model 202, classical machine learning model 204 or quantum machine learning model 206) to the respective dataset. The loss function of the entity can indicate how far the prediction of the entity is on each datapoint in the dataset from an accurate prediction, and the parameters of the entity can be optimized to minimize the loss function for the dataset. In case of weights, such as the error probabilities predicted by combination model 202 for the training set, the weights can measure the loss and skew the weighting of different samples and the extent to which the samples can contribute to the loss, for example, for quantum machine learning model 206.

At step 502, training dataset 520 can be preprocessed by applying a fit (e.g., fit ( ) function) on the training set, and a transform (e.g., transform ( ) function) on validation set 1, validation set 2 and test set. Preprocessing training dataset 520 can involve typical preprocessing steps employed to train machine learning models in most practical cases. At step 502A, training component 108 can perform categorical encoding to encode features in training dataset 520. For example, datasets can comprise different features such as purely numerical features (e.g., the height of a person, etc.) as well as categorical variables that can measure discreet values such as the biological identity of a person, the nationality of the person, etc. Categorical encoding can transform such features in training dataset 520 into a discreet set of values by specially encoding the features, and the encoding can allow the features to be processed by a machine learning model. The values resulting from the encoding can also be numerical values; however, the values typically do not have the same meanings as, for example, the numerical features that they are encoded from. At step 502B, training component can add missing value features to training dataset 520. For example, in practice, several feature values for different samples in training dataset 520 can be missing, and training component 108 can complete training dataset 520 to ensure that the machine learning models comprised in hybrid machine learning model 110 can process training dataset 520 appropriately. At step 502C, training component 108 can perform missing value imputation. For example, if a variable indicates that a feature is missing for a sample in training dataset 520, training component 108 can impute the missing value. Imputation can refer to filling in a missing value with a technique. An example of imputation can be mean imputation, wherein the mean of values across a dataset can be considered for a scenario where a value is not missing, and the mean can be employed as a missing value in a different scenario. In some implementations, zero (0) can be employed as the missing value or a machine learning process can be employed to derive a better guess for the missing value.

At step 504, training component 108 can apply a PQFM to the training data comprised in training dataset 520 to transform classical data into quantum data that can be employed to train quantum machine learning model 206. For example, quantum machine learning model 206 can be applied to training dataset 520 by applying a PQFM to validation set 1, validation set 2 and test to transform validation set 1, validation set 2 and test set via quantum computing, followed by fitting quantum machine learning model 206 to the training set based on the transformation. At step 504A, training component 108 can normalize the training data in training dataset 520. At step 504B, the PQFM can be employed to create a quantum feature map circuit for hyperparameters. At step 504C, composable quantum hardware can be employed to perform error suppression, error mitigation, mapping, and transpiling of the quantum feature map circuit. At step 504D, the quantum feature map circuit can be executed on a quantum system (e.g., quantum system 112) to measure specific observables for each sample. The PQFM can be part of quantum machine learning model 206. In some embodiments, the steps described at step 504 can be employed at step 510 as opposed to step 504. For example, at step 510, the PQFM can be employed to train quantum machine learning model 206. In some embodiments, a quantum neural network can be employed with the data from the training set without the transformation, or quantum support vector machines (SVMs) can be employed with the original data. However, applying the PQFM at step 504 can speed up the computational process.

A PQFM is a transformation that enables quantum enhanced modeling, and the PQFM is a quantum transformation of classical data, wherein classical data (e.g., from training dataset 520) can be loaded into a parametrized quantum circuit (e.g., a quantum circuit in quantum system 112) where the feature values of the classical data can be the parameters of the quantum circuit, such as the amount of the rotation in each rotation operation, etc. The PQFM is provided as a quantum machine learning process in Ansatz that can encode an input comprising classical data into a quantum circuit in a quantum state, after which a series of measurements can be extracted from a final quantum state of the quantum circuit. The set of extracted measurements can be acquired for each sample and employed as new features that can be quantum enhanced features. After generating the quantum enhanced features for each sample, different machine learning processes and models, such as quantum machine learning model 206 can be classically applied to the quantum enhanced features. In various embodiments, techniques other than a PQFM can also be employed to transform the training data of training dataset 520.

At step 506, training component 108 can train classical machine learning model 204 on the raw features from the training set. Any type of classical machine learning model can be employed for classical machine learning model 204 and upon training, classical machine learning model 204 can generate predictions (e.g., predict ( ) function) on validation set 1. For example, at step 506A, training component 108 can standardize data in the training set. At step 506B, training component 108 can initialize classical machine learning model 204 and train classical machine learning model 204 on the training set. At step 506C, training component 108 can employ classical machine learning model 204 to generate predictions on validation set 1.

At step 508, training component can train combination model 202 on raw features from validation set 1 and the predictions generated by classical machine learning model 204. For example, at step 508A, training component 108 can generate error labels based on the predictions generated by classical machine learning model 204. As such, a new set of labels can be generated based on validation set 1. At step 508B, training component 108 can standardize data in validation set 1. At step 508C, training component 108 can initialize combination model 202 and train combination model 202 on validation set 1 with the error labels. In various embodiments, a machine learning pipeline can be employed to train a desired machine learning model for combination model 202. In some embodiments, combination model 202 can be the same type of machine learning model as classical machine learning model 204. For example, the same class of models such as gradient boosting models can be employed for combination model 202 and classical machine learning model 204. In other embodiments, combination model 202 can be a quantum machine learning model. At step 508D, training component 108 can employ combination model 202 to predict error probabilities for classical machine learning model 204 based on the training set. The error probabilities can be the out-of-sample predictions of combination model 202, as described in greater detail in non-limiting method 400.

At step 510, training component 108 can train quantum machine learning model 206 with PQFM features on the training set weighted according to the error probabilities predicted by combination model 202. For example, at step 510A, training component 108 can standardize data in the training set. At step 510B, training component 108 can initialize quantum machine learning model 206 and train quantum machine learning model 206 with PQFM features and error probabilities of combination model 202 as weights of the samples comprised in the training set. At this stage, classical machine learning model 204 can be optionally trained on the training set with (1−the error probabilities) as weights of the samples comprised in the training set.

At step 512, training component 108 can employ validation set 2 and the test set to generate respective predictions of combination model 202, classical machine learning model 204 and quantum machine learning model 206, and combination model 202 can combine the respective predictions generated by classical machine learning model 204 and quantum machine learning model 206 to generate a final prediction. For example, at step 512A, training component 108 can standardize data in validation set 2 and the test set. At step 512B, training component 108 can obtain respective predictions of combination model 202 and classical machine learning model 204 on validation set 2 and the test set for raw features, and further obtain predictions of quantum machine learning model 206 for PQFM features. At step 512C, training component 108 can generate a final prediction that can be given by EM*QM+ (1−EM)*CM, wherein EM represents the prediction generated by combination model 202, QM represents the prediction generated by quantum machine learning model 206 and CM represents the prediction generated by classical machine learning model 204. At step 512D, training component 108 can select the hyperparameters for the PQFM, combination model 202, classical machine learning model 204 and quantum machine learning model 206 based on the final predictions/scores. For example, the respective predictions of combination model 202, classical machine learning model 204 and quantum machine learning model 206 can be generated on validation set 2 for different respective hyperparameters of the models, followed by selecting the best hyperparameters based on the respective predictions.

Non-limiting method 500 can be repeated for multiple splits when employing a cross-validation technique instead of explicit validation sets. Non-limiting method 500 can also be repeated for each hyperparameter combination of the PQFM, combination model 202, classical machine learning model 204 and quantum machine learning model 206 by caching the hyperparameters of the PQFM. Further, different models and pipelines can be plugged in for each of steps 506, 508 and 510 to generate different results.

In this regard, the hyperparameters of the PQFM, combination model 202, classical machine learning model 204 and quantum machine learning model 206 can be tuned by various techniques. For example, in some embodiments, the respective hyperparameters of the PQFM, combination model 202, classical machine learning model 204 and quantum machine learning model 206 can be collectively tuned by employing a dedicated validation set (e.g., validation set 2). In other embodiments, the respective hyperparameters of the PQFM, combination model 202, classical machine learning model 204 and quantum machine learning model 206 can be individually tuned via internal cross-validation, which is a standardized machine learning process, during the respective training steps of non-limiting method 500 based on the datasets employed during the respective training steps. For example, at step 506, the hyperparameters of classical machine learning model 204 can be tuned via internal cross-validation to independently select the hyperparameters of classical machine learning model 204 to fit classical machine learning model 204 on the training set. However, the process of individually tuning the hyperparameters of the PQFM, combination model 202, classical machine learning model 204 and quantum machine learning model 206 can be time consuming as opposed to employing a single validation set that can allow various combinations of hyperparameters across different models to be considered during the training. For example, validation set 2 can enable efficient and collective tuning of the hyperparameters of the PQFM, combination model 202, classical machine learning model 204 and quantum machine learning model 206.

FIG. 6 illustrates a flow diagram of an example, non-limiting method 600 that can perform selective training of classical machine learning models and quantum machine learning models by employing an iterative technique in accordance with one or more embodiments described herein. Repetitive description of like elements and/or processes employed in respective embodiments is omitted for sake of brevity.

Non-limiting method 600 describes additional embodiments with respect to the iterative technique discussed in FIG. 1. As stated supra, the iterative technique can be an extension of the error-based technique wherein the weights assigned to respective samples of training dataset 105 can be iteratively updated to define different subsets of training data comprised in training dataset 105 as being more applicable to classical machine learning model 204 or quantum machine learning model 206. The iterative technique can enable a more nuanced assignment of weights to samples in the training set, since training dataset 105 can comprise some samples or features that can be suitable to train both classical machine learning model 204 and quantum machine learning model 206. By employing the iterative approach, the weights assigned to the samples comprised in the training set can be iteratively refined, as opposed to selecting the weights for the samples based only on the erroneous predictions generated by classical machine learning model 204.

Non-limiting method 600 can begin with the error-based technique, wherein combination model 202 can select and assign (e.g., via weights assignment component 302) different respective weights to samples of a training set (e.g., training set of FIG. 5) comprised in training dataset 105, based on the erroneous predictions generated by classical machine learning model 204, to generate a first subset of the training set comprising samples with weights suitable to train classical machine learning model 204 and a second subset of the training set comprising samples with weights suitable to train quantum machine learning model 206. Similar to the error-based technique, training component 108 can train quantum machine learning model 206 on the second subset of the training set and retrain classical machine learning model 204 on the first subset of the training set. Stated differently, classical machine learning model 204 and quantum machine learning model 206 can both be trained on the training set but with the samples in the training set weighted differently to train each model. After the training, classical machine learning model 204 and quantum machine learning model 206 can be employed to generate respective predictions, for example, on validation set 1 (e.g., validation set 1 of FIG. 5) comprised in training dataset 105.

Combination model 202 can analyze the respective predictions to update/reassign the weights previously assigned to the samples comprised in the training set. For example, combination model 202 can analyze predictions 604 generated by classical machine learning model 204 and predictions 606 generated by quantum machine learning model 206 on validation set 1, and combination model 202 can assign higher weights to the samples in the training set for which predictions 606 can be more accurate than predictions 604, or to the samples for which predictions 606 and predictions 604 can be equally accurate. The process can be repeated until combination model 202 converges. In various embodiments, updating the weights assigned to the samples in the training set can lead to new classical machine learning models and new quantum machine learning models.

In practice, the training and validation sets were switched. For example, classical machine learning model 204 and quantum machine learning model 206 were trained on a training set with existing weights assigned to the samples in the training set followed by obtaining model predictions on validation set 1. Thereafter, new weights based on validation set 1 were determined according to the relative error of each base model (i.e., classical machine learning model 204, quantum machine learning model 206, and any other quantum and classical machine learning models). For example, for a binary classification, if classical machine learning model 204 generates a probability of class 1 as C(x) and quantum machine learning model 206 generates a probability of class 1 as Q(x), then for each data point x having a label of class 1 in validation set 1, higher values of C(x) can indicate that classical machine learning model 204 is more accurate and higher values of Q(x) can indicate that quantum machine learning model 206 is more accurate. Thus, a new weight assigned to a sample directed to classical machine learning model 204 can be

$$\frac{C ( x )}{( C ( x ) + Q ( x ) )}$$

if the true label for x is 1, and the new classical weight can be

$$1 - [ \frac{Q ( x )}{( C ( x ) + Q ( x ) )} ]$$

if the true label for x is not 1. Doing so can generate a new validation set that can be employed as a new training set with new sample weights directed to each model (with the weights for samples direct to classical machine learning model 204 being 1−the weights for samples directed to quantum machine learning model 206). Next, both the base models can be trained on the new training set with the new weights and the predictions of each base model can be obtained by employing the original training set as the new validation set. The process can be repeated back and forth between the training and validation sets.

In an embodiment, the predictions on each holdout set (i.e., the training set or the validation set) can be employed to train a separate machine learning model that can be employed as the error model (i.e., combination model 202) to predict which base model can generate more accurate predictions and employ the model to assign new weights to the original training set. As before, the process can alternate back and forth between holdout sets. In another embodiment, two error models (such as combination model 202) can be trained, wherein a first error model can be trained to predict the probability of error for classical machine learning model 204 and a second error model can be trained to predict the probability of error for quantum machine learning model 206. Both error models can be employed to generate and assign new weights, as before, to samples comprised in the training set. For example, the new weight for a sample from the training set can be

$$\frac{CE ( x )}{( CE ( x ) + QE ( x ) )}$$

to assign the sample to quantum machine learning model 206. Thus, in some embodiments, the training set can be selected as the validation set and vice versa, and the selection can be flipped during each training cycle, whereas in other embodiments, an additional model can be trained on the validation set to generate new weights for samples in the training set, followed by retraining the base models on the training set with the new weights. The former approach of flipping the validation and training sets can lead to a new training dataset. All training in the implementations described herein can be performed by training component 108.

In some embodiments, non-limiting method 600 can begin with uniform weighting of the samples comprised in the training set of training dataset 105 as opposed to weighting the samples according to the error-based technique. For example, classical machine learning model 204 and quantum machine learning model 206 can first be trained on uniformly weighted samples comprised in the training set, that is, on samples having equal weighting. Based on initial predictions of the trained models on validation set 1 (e.g., validation set 1 of FIG. 5), combination model 202 can select different respective weights for samples comprised in the training set, and classical machine learning model 204 and quantum machine learning model 206 can be retrained based on the updated weights. The process can repeat until combination model 202 converges. The weights assigned by combination model 202 can be continuous values (values between 0 and 1) or binary values (0 or 1). In various embodiments, updating the weights for samples comprised in the training set can generate a new training set, such as training dataset 602, during each iteration of non-limiting method 600.

In an embodiment, non-limiting method 600 can comprise updating the weights assigned to respective samples in the training set without iteratively retraining classical machine learning model 204 and quantum machine learning model 206, until combination model 202 converges, as illustrated by process 608A. Thereafter, classical machine learning model 204 and quantum machine learning model 206 can be trained by training component 108 based on the final weights assigned to the respective samples in the training set. Training component 108 can also train combination rule component 304 comprised in combination model 202 to predict weights that can be applied to test samples comprised in a test set (e.g., the test set of FIG. 5) on which classical machine learning model 204 and quantum machine learning model 206 can generate respective predictions, since the weights for the test samples are unknown at the time of predicting. Combination rule component 304 can employ a combination rule to predict the weights for the test samples, and based on the weights, combination rule component 304 can combine the respective predictions generated by classical machine learning model 204 and quantum machine learning model 206 on the test set to generate final prediction 610.

In another embodiment, combination rule component 304 can be part of the iterative technique, as illustrated by process 608B. For example, after the weights for the samples in the training set are updated, training component can train combination model 202 during each iteration of non-limiting method 600 to predict weights that can be applied to test samples comprised in a test set on which classical machine learning model 204 and quantum machine learning model 206 can generate respective predictions, and combination model 202 can employ the weights predicted by combination rule component 304 to retrain classical machine learning model 204 and quantum machine learning model 206. Process 608B can be more reflective of how non-limiting method 600 can be applied in practice because the predictions of combination rule component 304 can be different from the original sample weights. Thus, including combination rule component 304 as part of the iterative technique can be beneficial to tune classical machine learning model 204 and quantum machine learning model 206 to work more efficiently with combination model 202.

FIG. 7 illustrates a flow diagram of an example, non-limiting method 700 that can perform selective training of classical machine learning models and quantum machine learning models by employing an error clustering technique in accordance with one or more embodiments described herein. Repetitive description of like elements and/or processes employed in respective embodiments is omitted for sake of brevity.

Non-limiting method 700 elaborates on the error clustering technique discussed with reference to FIG. 1. The error clustering technique considers the geometric relationships between data points in a dataset to identify regions of the dataset comprising samples that can be within a defined distance from one another. Such regions of the dataset can be employed to train classical machine learning model 204 and quantum machine learning model 206. More specifically, the error clustering technique can employ a distance-based approach to define parts of training dataset 105 via clusters based on erroneous predictions generated by classical machine learning model 204, wherein the clusters can be employed to train classical machine learning model 204 and/or quantum machine learning model 206. Further, the distances between samples can be employed as sample weights or decisions to select the model to be applied to generate predictions on new data.

In various embodiments, training data comprised in training dataset 105 can be clustered to identify regions of the training data that can generate errors in predictions of classical machine learning model 204 and regions that do not generate errors in the predictions of classical machine learning model 204. In an embodiment, non-limiting method 700 can begin with the error-based technique to assign respective first weights that can be applied to a first subset of a training set (e.g., the training set of FIG. 5) comprised in training dataset 105 and respective second weights that can be applied to a second subset of the training set comprised in training dataset 105, wherein the first subset can be applicable to train classical machine learning model 204 and the second subset can be applicable to train quantum machine learning model 206, and additional steps can be performed to identify different clusters of data to evaluate classical machine learning model 204 and quantum machine learning model 206.

For example, training component 108 can train classical machine learning model 204 on the training set to generate predictions, and combination model 202 can cluster the samples comprised in the training set based on erroneous predictions 702 generated by classical machine learning model 204 on validation set 1 (e.g., validation set 1 of FIG. 5) out of all the predictions generated by classical machine learning model 204. For example, training component 108 can employ error labels based on erroneous predictions 702 comprised in the predictions generated by classical machine learning model 204 to train combination model 202 on validation set 1. In this regard, training component 108 can train combination model 202 to learn the clustering of erroneous predictions generated by classical machine learning model 204. Upon training, combination model 202 can be applied to the training set to identify the samples on which classical machine learning model 204 is likely to generate erroneous predictions on, and combination model 202 can group such samples into one or more error clusters, such as cluster 704B, based on the geometric relationships of the samples. Training component 108 can train quantum machine learning model 206 on the one or more error clusters. In an embodiment, combination model 202 can additionally identify samples in the training set that classical machine learning model 204 is likely to generate accurate predictions on, and combination model 202 can cluster such samples into one or more correct clusters, such as cluster 704A, based on the geometric relationships of the samples. In this embodiments, training component 108 can retrain classical machine learning model 204 on the one or more correct clusters. In general, the clustering of the samples comprised in the training set can generate training dataset 704 that can be employed to train at least quantum machine learning model 206. Further, training dataset 704 can be saved in memory and made accessible to hybrid machine learning model 110 for future predictions.

As a final step during validation, training component 108 can tune the distance of a sample to an error cluster such as cluster 704B. For example, training component 108 can define a distance threshold for closeness/proximity of a sample in a test set (e.g., the test set of FIG. 5) to cluster 704B, and the distance threshold can be employed by combination model 202 to determine whether classical machine learning model 204 or quantum machine learning model 206 should generate a prediction for the sample. For example, combination model 202 can employ combination rule component 304 that can select the correct machine learning model (e.g., classical machine learning model 204 or quantum machine learning model 206) to apply to generate the prediction, based on a combination rule and the distance threshold. For example, sample 706 from the test set can be located at distance 708 from cluster 704B, and distance 708 can be less than or equal to the distance threshold defined by training component 108. As a result, combination rule component 304 can select quantum machine learning model 206 to generate a prediction for sample 706. Otherwise, classical machine learning model 204 can be employed.

In some embodiments, soft clustering can be employed instead of a hard threshold to define the error clusters and the correct clusters. For example, a mixture model can be employed for combination model 202, and a probability of a sample being in both cluster 704A, and cluster 704B can be considered. Thus, instead of cluster 704A and cluster 704B being separated by a hard boundary, there can be some overlap between the clusters such that a sample have a greater probability of belonging to one cluster and a small probability of belonging to another cluster. Thus, in at least some embodiments, a new sample can be assessed based on whether the new sample is in the region of error (i.e., the error clusters). As explained supra, the error clustering technique can be based on out-of-sample predictions of classical machine learning model 204, either via cross-validation on the training set or with a separate holdout set, similar to the error-based technique.

A cluster can be a hyper-spherical distribution. Additionally, assigning new samples to classical machine learning model 204 or quantum machine learning model 206 can be based on the mean values/means, covariance matrices, and/or other parameters of the different clusters comprised in training dataset 704. For example, combination model 202 can measure the distance threshold of a sample from the respective clusters based on the means of the respective clusters. For example, in case employing only the means of each cluster, sample 706 can most likely belong to cluster 704B if sample 706 is within the distance threshold from the mean of cluster 704B or closer to the mean of cluster 704B than to the means of other clusters.

In some embodiments, the distance threshold employed by combination rule component 304 in the combination rule can be tuned with validation set 2 (e.g., validation set 2 of FIG. 5), and the combination rule can define how close a sample needs to be to a cluster comprised in training dataset 704 to be considered as coming from that cluster. As noted earlier, new samples can be assigned to clusters in a binary fashion, wherein a sample can be assigned to a cluster based on the boundaries defining the cluster, or the sample can be assigned to a cluster based on a probability of the sample being in the cluster or another cluster. In either implementation, the distance threshold can be further tuned according to validation set 2. For example, a sample can be closest to an error cluster than any other cluster, and the distance threshold can be defined to indicate that the sample needs to be within a certain distance from an error cluster to be considered a part of that error cluster. Thus, hybrid machine learning model 110 can be tuned in a flexible manner accordingly to the specific application.

In some embodiments, final prediction 710 can be generated by classical machine learning model 204 or quantum machine learning model 206 based on the distance of a sample from one or more clusters of training dataset 704. In other embodiments, a weighted sample approach can be employed where both classical machine learning model 204 and quantum machine learning model 206 can be employed to generate respective predictions, and combination model 202 can employ combination rule component 304 to weight the respective predictions and generate final prediction 710, such as in the case of the error-based technique.

FIG. 8 illustrates a flow diagram of an example, non-limiting method 800 that can perform selective training of classical machine learning models and quantum machine learning models by employing a cluster-first technique in accordance with one or more embodiments described herein. Repetitive description of like elements and/or processes employed in respective embodiments is omitted for sake of brevity.

Non-limiting method 800 describes the cluster-first technique discussed with reference to FIG. 1. Similar to the error-clustering technique, the cluster-first technique employs a distance-based approach to define different respective subsets of training dataset 105 that can be employed to train classical machine learning model 204 and quantum machine learning model 206.

In various embodiments, training component 108 can partition training dataset 105 into two or more clusters based on geometric relationships of samples comprised in training dataset 105. Clustering the samples from training dataset 105 can generate training dataset 802, and training component 108 can train both classical machine learning model 204, and quantum machine learning model 206, on each cluster comprised in training dataset 802. Based on the predictions generated by classical machine learning model 204 and quantum machine learning model 206 for each cluster, combination model 202 can assign the clusters to classical machine learning model 204 or quantum machine learning model 206. For example, combination model 202 can be trained by training component 108 to analyze the accuracies of predictions generated by classical machine learning model 204 and quantum machine learning model 206 for each cluster. If a prediction generated by classical machine learning model 204 for a cluster has accuracy above a defined accuracy threshold, the cluster can be assigned to classical machine learning model 204, otherwise the cluster can be assigned to quantum machine learning model 206. Likewise, if a prediction generated by quantum machine learning model 206 for a cluster has accuracy above a defined threshold, the cluster can be assigned to quantum machine learning model 206, otherwise the cluster can be assigned to classical machine learning model 204. For example, cluster 804 can be assigned to classical machine learning model 204 and clusters 806 and 808 can be assigned to quantum machine learning model 206.

Assigning clusters to a machine learning model can indicate that predictions for new samples, for example, samples from a test set, can be generated by the machine learning model based on the assigned clusters and a distance metric. For example, combination model 202 can be further trained by training component 108 to analyze the distance of a sample comprised in a test set with respect to the clusters comprised in training dataset 802. If the distance is within a first defined threshold to a cluster assigned to classical machine learning model 204, combination model 202 can select classical machine learning model 204 to generate a prediction for the sample. Similarly, if the distance is within a second defined threshold to a cluster assigned to quantum machine learning model 206, combination model 202 can select quantum machine learning model 206 to generate the prediction for the sample.

In an embodiment, the assignment of the sample to a cluster can be a hard assignment wherein a sample can only belong to a single cluster. For example, as illustrated by the dashed arrows and the “X” marks in FIG. 8, a first sample from a test set can be assigned to classical machine learning model 204 (as opposed to quantum machine learning model 206) if the first sample is within a defined distance threshold from cluster 804, a second sample from the test set can be assigned to quantum machine learning model 206 if the second sample is within a defined distance threshold from cluster 806, and a third sample from the test set can be assigned to quantum machine learning model 206 if the third sample is within a defined distance threshold from cluster 808. In another embodiment, the assignment can be a soft assignment wherein the sample can be weighted according to relative performances of classical machine learning model 204 or quantum machine learning model 206 on each cluster. For example, the distance between a sample and a cluster can be optionally employed as a weight or decision to apply classical machine learning model 204 or quantum machine learning model 206. The techniques and embodiments employed to assign new samples to machine learning models in the cluster-first technique can be similar to those employed in the error-clustering technique.

In an embodiments, the distances of respective samples comprised in a test set can be further employed by combination model 202 as respective weights to weight the respective predictions generated by classical machine learning model 204 and quantum machine learning model 206 and generate final prediction 810. Combination model 202 can employ combination rule component 304 and a combination rule based on the distance to combine the respective predictions generated by classical machine learning model 204 and generate final prediction 810. The cluster-first technique can improve the performance of both classical machine learning model 204, and quantum machine learning model 206, since quantum training data that can be noise for classical machine learning model 204 can be assigned to quantum machine learning model 206, and vice versa.

FIG. 9 illustrates a flow diagram of an example, non-limiting method 900 that can perform selective training of classical machine learning models and quantum machine learning models by employing a partition optimization technique in accordance with one or more embodiments described herein. Repetitive description of like elements and/or processes employed in respective embodiments is omitted for sake of brevity.

Non-limiting method 900 described the partition optimization technique discussed with reference to FIG. 1. In contrast to the error-based technique wherein erroneous predictions of classical machine learning model 204 can be employed to weight samples in a holdout training set comprised in training dataset 105, the partition optimization technique can employ a score-based metric to determine subsets of training dataset 105 that can be more suitable to train classical machine learning model 204 versus subsets of training dataset 105 that can be more suitable to train quantum machine learning model 206. For example, in various embodiments, different metrics can be employed to estimate the benefits of applying quantum machine learning model 206 versus classical machine learning model 204 on training dataset 105, and the metrics can be further employed to determine subsets of training dataset 105 that can result in a better score for quantum machine learning model 206. For example, for certain types of quantum machine learning models and classical machine learning models, the ratio of respective complexity scores for quantum machine learning model 206 and classical machine learning model 204 for a dataset can result in generalization error bounds for each model. For example, if complexity score 904 of classical machine learning model 204 divided by complexity score 902 of quantum machine learning model 206 is larger than a defined value, then classical machine learning model 204 can be expected to perform better on training dataset 105 than quantum machine learning model 206.

In some embodiments, the partition optimization technique can be based on an optimized partitioning rule derived from quantum complexity measures/scores. For example, combination model 202 can employ a quantum complexity score to partition training dataset 105 into first subsets of training data comprised in training dataset 105 that can be more suitable to train classical machine learning model 204 and second subsets of training data comprised in training dataset 105 that can be more suitable to train quantum machine learning model 206. As stated elsewhere herein, by training classical machine learning model 204 and quantum machine learning model 206 on differently weighted samples applicable to each model, the performances of both classical machine learning model 204, and quantum machine learning model 206 can be improved by reducing the amount of noise in the respective subsets employed to train each model.

Combination model 202 can optimize the quantum complexity score for each of classical machine learning model 204 and quantum machine learning model 206 via an optimization process to identify portions of training dataset 105 that can optimize the score. For example, in an embodiment, combination model 202 can generate complexity score 902 for quantum machine learning model 206 and generate complexity score 904 for classical machine learning model 204. Based on complexity score 904, combination model 202 can assign respective first weights to a first subset of training data comprised in training dataset 105, and based on complexity score 902, combination model 202 can assign respective second weights to a second subset of training data comprised in training dataset 105. Combination model 202 can further employ an iterative optimization process to maximize complexity score 902 and minimize complexity score 904, such that during each iteration of the iterative optimization process, combination model 202 can update complexity score 904 based on the respective first weights and update complexity score 902 based on the respective second weights. Further, combination model 202 can select new respective first weights and new respective second weights resulting in new first and second subsets of training dataset 105, based on the updated complexity scores. In general, combination model 202 can update the respective weights assigned to samples comprised in the training data of training dataset 105 until the complexity scores 902 and 904 are individually optimized.

The iterative optimization process can continue until convergence of combination model 202, resulting in subset 906 that can be employed by training component 108 to train quantum machine learning model 206, and subset 908 that can be employed by training component 108 to train classical machine learning model 204. Thus, quantum machine learning model 206 can be trained on training data that can maximize the quantum complexity score and classical machine learning model 204 can be trained on training data that can minimize the quantum complexity score. The trained models can be employed by training component 108 to generate predictions on a test set. In various embodiments, scores other than the quantum complexity score can also be employed to partition training dataset 105 via the iterative optimization process. In various embodiments, combination model 202 can employ combination rule component 304 to combine the respective predictions generated by classical machine learning model 204 and quantum machine learning model 206 on the test set. Training component 108 can train combination rule component 304 to predict weights for samples comprised in the test set, and the weight for a sample can be converted into a probability of the sample belonging to a quantum data distribution versus a classical data distribution. Combination rule component 304 can be trained to apply the probability to the sample to weigh the respective predictions generated by classical machine learning model 204 and quantum machine learning model 206 to generate final prediction 910.

More specifically, in the partition-optimization technique, the weights assigned to samples in training dataset 105 can be optimized across the entire dataset to maximize the quantum complexity score/ratio across training dataset 105. The quantum complexity score/ratio can be equal to the model complexity of classical machine learning model 204 divided by the model complexity for quantum machine learning model 206 for defined sample weights. These weights of the samples can then be employed to determine the weights that can be employed by training component 108 to train quantum machine learning model 206 and/or classical machine learning model 204. The weights can also be employed by combination model 202 to select first and second subsets of training dataset 105 to train classical machine learning model 204 and quantum machine learning model 206, respectively. For example, employing optimal sample weights can be assigned to samples to train quantum machine learning model 206 on the samples, and inverse values of the optimal samples weights can be assigned as weights to the samples to train classical machine learning model 204. In an embodiments, combination model 202 can determine the weights applicable to train classical machine learning model 204 by employing the inverse quantum complexity ratio. In this embodiments, combination model 202 can also be trained to predict or provide the sample weights/relative weights for unseen/future data points.

For example, to determine weights w1, w2, w3 and w4 for samples x1, x2, x3 and x4, respectively, to optimize the quantum complexity ratio given samples weights w, combination model 202 can solve for sample weights w that can maximizes the quantum complexity ratio. This generates sample weights that can be applicable to quantum machine learning model 206. For example, a solution of w1, w2, w3, and w4, wherein w1 and w4 can be much larger than w2 and w3 can be obtained, indicating that training component 108 can train quantum machine learning model 206 with a greater focus on samples x1 and x4 with respective weights w1 and w4, and less focus on samples x2 and x3 with respective sample weights w2 and w3.

On the contrary, training component 108 can train classical machine learning model 204 with more focus on samples x2 and x3 and less focus on samples x1 and x4. Thus, optimizing the quantum complexity score can directly generate respective first weights applicable to classical machine learning model 204 and second respective weights applicable to quantum machine learning model 206. In other words, optimizing the quantum complexity score can generate a partition of training dataset 105. In case of a new sample, x5, the weight, w5, of sample, x5, can be unknown and therefore, the specific machine learning model or the prediction weighting to be employed to combine respective predictions generated by classical machine learning model 204 and quantum machine learning model 206 can also be unknown. Thus, in various embodiments, training component 108 can train combination model 202 as a machine learning model to predict weights for new samples and employ combination model 202 to predict respective samples weights w5 for sample x1 for classical machine learning model 204 and quantum machine learning model 206. Thus, the partition-optimization technique can optimize the partitions of training data from training dataset applicable to train classical machine learning model 204 and quantum machine learning model 206 or directly divide or weight the training data differently for classical machine learning model 204 and quantum machine learning model 206.

In an embodiment, the solution can be obtained for a hard partition. For example, weights of 0 and 1 for sample in the training data, with a weight of 1 indicating that the sample can be employed to train quantum machine learning model 206 and a weight of zero (0) indicating that the sample can be employed to train classical machine learning model 204. In another embodiment, the solution can be obtained for a soft partition. For example, the weight for a sample in the training data can be any value (e.g., v) between 0 and 1. The sample with weight v can be employed to train quantum machine learning model 206, and the sample with weight (1−v) can be employed to train classical machine learning model 204. In yet another embodiment, combination model 202 can optimize the quantum complexity score simultaneously for a separate set of weights for classical machine learning model 204, because the weights do not need to add up to 1. For example, it can be desirable to discard some samples from the training subsets for both classical machine learning model 204, and quantum machine learning model 206 instead of assigning such samples to either model, or it can be desirable to employ a sample equally for both models.

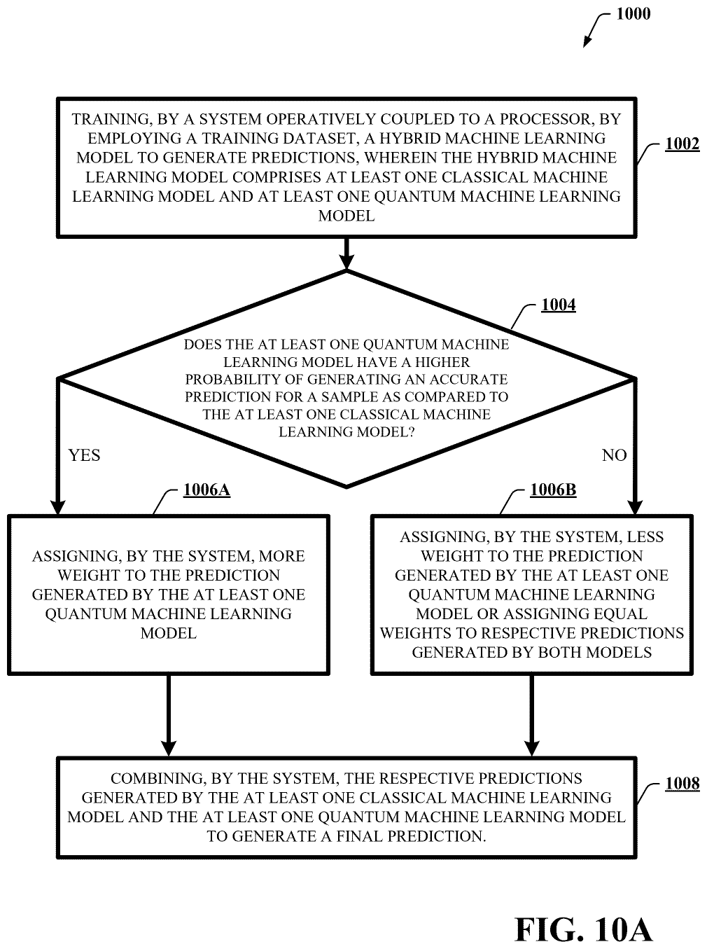

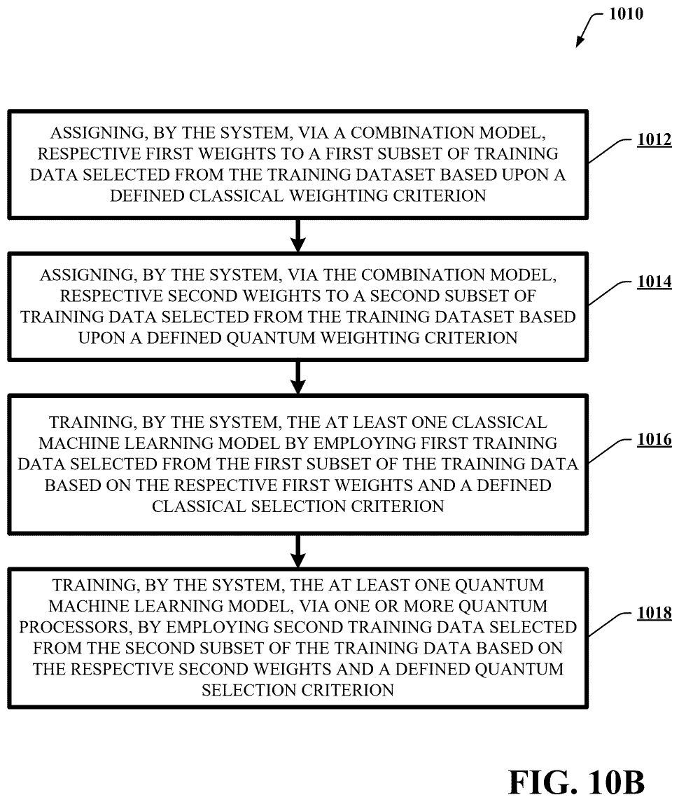

FIG. 10A illustrates a flow diagram of an example, non-limiting method 1000 that can perform selective training of classical machine learning models and quantum machine learning models in accordance with one or more embodiments described herein. Repetitive description of like elements and/or processes employed in respective embodiments is omitted for sake of brevity.

At 1002, non-limiting method 1000 can comprise training (e.g., by training component 108), by a system operatively coupled to a processor, by employing a training dataset, a hybrid machine learning model to generate predictions, wherein the hybrid machine learning model comprises at least one classical machine learning model and at least one quantum machine learning model.

At 1004, non-limiting method 1000 can comprise determining (e.g., by combination model 202 or combination rule component 304), by the system, if the at least one quantum machine learning model has a higher probability of generating an accurate prediction for a sample as compared to the at least one classical machine learning model.

If yes, at 1006A, non-limiting method 1000 can comprise assigning (e.g., by combination model 202 or combination rule component 304), by the system, more weight to the prediction generated by the at least one quantum machine learning model.

If not, at 1006B, non-limiting method 1000 can comprise assigning (e.g., by combination model 202 or combination rule component 304), by the system, less weight to the prediction generated by the at least one quantum machine learning model or assigning (e.g., by combination model 202 or combination rule component 304) equal weights to respective predictions generated by both the at least one classical machine learning model and the at least one quantum machine learning model.

At 1008, the non-limiting method 1000 can comprise combining (e.g., by combination model 202 or combination rule component 304), by the system, the respective predictions generated by the at least one classical machine learning model and the at least one quantum machine learning model to generate a final prediction.

FIG. 10B illustrates a flow diagram of an example, non-limiting method 1010 that can perform selective training of classical machine learning models and quantum machine learning models in accordance with one or more embodiments described herein. Repetitive description of like elements and/or processes employed in respective embodiments is omitted for sake of brevity.

Non-limiting method 1010 illustrates additional aspects of training the hybrid machine learning model discussed in non-limiting method 1000.

At 1012, non-limiting method 1010 can comprise assigning (e.g., by combination model 202), by the system, respective first weights to a first subset of training data selected from the training dataset based upon a defined classical weighting criterion.

At 1014, non-limiting method 1010 can comprise assigning (e.g., by combination model 202), by the system, respective second weights to a second subset of training data selected from the training dataset based upon a defined quantum weighting criterion.

At 1016, non-limiting method 1010 can comprise training (e.g., by training component 108), by the system, the at least one classical machine learning model by employing first training data selected from the first subset of the training data based on the respective first weights and a defined classical selection criterion.

At 1018, non-limiting method 1010 can comprise training (e.g., by training component 108), by the system, the at least one quantum machine learning model, via one or more quantum processors, by employing second training data selected from the second subset of the training data based on the respective second weights and a defined quantum selection criterion.

As stated elsewhere herein, training a quantum machine learning model on an entire dataset can cause the quantum machine learning model to be trained on training data that can be more suitable for classical modeling and distort the training data that can be more suitable for quantum modeling, resulting in a reduced performance of the quantum machine learning model. Similarly, quantum data can be processed as noise by the classical machine learning model. The embodiments disclosed herein can automatically direct quantum machine learning models and classical machine learning models comprised in a hybrid machine learning model on respectively appropriate subsets of a training dataset/data distribution. Defining subsets of the training dataset where classical machine learning models can perform poorly by assigning higher weights to samples comprised in the subsets and applying quantum machine learning to the subsets can result in a higher overall performance/prediction score of the hybrid machine learning model. Additionally, the respective performances of the classical and quantum machine learning models can also improve since training data that can be more appropriate to train a quantum machine learning model can be processed as noise by the classical machine learning model, and vice versa. By directing the classical and quantum machine learning models to different subsets of the training dataset, the embodiments herein can be scaled to larger datasets. The techniques disclosed herein can be applied across samples in a dataset (i.e., the data point dimension) as well as across features of the samples (i.e., the feature dimension).

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

FIG. 11 illustrates a block diagram of an example, non-limiting, operating environment in which one or more embodiments described herein can be facilitated. FIG. 11 and the following discussion are intended to provide a general description of a suitable operating environment 1100 in which one or more embodiments described herein at FIGS. 1-10 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1100 contains an example of an environment for the execution of at least some of the computer code involved in performing the inventive methods, such as hybrid training data segregation code 1126. In addition to block 1126, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1126, as identified above), peripheral device set 1114 (including user interface (UI), device set 1123, storage 1124, and Internet of Things (IOT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible. Computer 1101 may be located in a cloud, even though it is not shown in a cloud in FIG. 11. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in block 1126 in persistent storage 1113.

COMMUNICATION FABRIC 1111 is the signal conduction paths that allow the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid state storage devices. Operating system 1122 may take several forms, such as various known proprietary operating systems or open source Portable Operating System Interface type operating systems that employ a kernel. The code included in block 1126 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system comprising:
a memory that stores computer executable components; and
a processor that executes the computer executable components stored in the memory, wherein the computer executable components comprise:
a training component that trains, by employing a training dataset, a hybrid machine learning model to generate predictions, wherein the hybrid machine learning model comprises at least one classical machine learning model and at least one quantum machine learning model, and wherein training the hybrid machine learning model comprises:
assigning, by employing a combination model, respective first weights to a first subset of training data selected from the training dataset based upon a defined classical weighting criterion;
assigning, by employing the combination model, respective second weights to a second subset of training data selected from the training dataset based upon a defined quantum weighting criterion;
training the at least one classical machine learning model by employing first training data selected from the first subset of the training data based on the respective first weights and a defined classical selection criterion; and
training the at least one quantum machine learning model, via one or more quantum processors, by employing second training data selected from the second subset of the training data based on the respective second weights and a defined quantum selection criterion.

2. The system of claim 1, wherein the combination model combines respective predictions generated by the at least one classical machine learning model and the at least one quantum machine learning model to generate a final prediction.

3. The system of claim 1, wherein the training the hybrid machine learning model further comprises:
training the at least one classical machine learning model on a training set comprised in the training dataset;
training the combination model on a validation set comprised in the training dataset by employing error labels based on erroneous predictions generated by the at least one classical machine learning model based on the validation set comprised in the training dataset;
predicting, by employing the combination model, error probabilities indicative of the at least one classical machine learning model generating new erroneous predictions based on the training set comprised in the training dataset;
selecting, by employing the combination model, the respective first weights and the respective second weights based on the error probabilities; and
combining, by employing the combination model, respective predictions generated by the at least one classical machine learning model and the at least one quantum machine learning model based on a different validation set comprised in the training dataset and a test set, after the training of the hybrid machine learning model.

4. The system of claim 3, wherein the training the hybrid machine learning model further comprises:
iteratively updating, by employing the combination model, the respective first weights and the respective second weights based on respective accuracies of the respective predictions; and
retraining the at least one classical machine learning model and the at least one quantum machine learning model based on the updating.

5. The system of claim 1, wherein the training the hybrid machine learning model further comprises:
training the at least one classical machine learning model on a training set comprised in the training dataset;
training the combination model on a validation set comprised in the training dataset by employing error labels based on erroneous predictions generated by the at least one classical machine learning model based on the validation set comprised in the training dataset;
predicting, by employing the combination model, error probabilities indicative of the at least one classical machine learning model generating new erroneous predictions based on the training set comprised in the training dataset;
grouping, by employing the combination model, samples from the training set associated with the new erroneous predictions into at least one cluster; and
training the at least one quantum machine learning model based on the at least one cluster.

6. The system of claim 1, wherein the training the hybrid machine learning model further comprises:
partitioning the training dataset into two or more clusters;
training the at least one classical machine learning model and the at least one quantum machine learning model on the two or more clusters;
generating, by employing the at least one classical machine learning model, respective first predictions on respective clusters of the two or more clusters;
generating, by employing the at least one quantum machine learning model, respective second predictions on the respective clusters of the two or more clusters;
assigning respective first clusters of the two or more clusters to the at least one classical machine learning model based on the respective first predictions; and
assigning respective second clusters of the two or more clusters to the at least one quantum machine learning model based on the respective second predictions.

7. The system of claim 1, wherein the training the hybrid machine learning model further comprises:
generating a first optimized quantum complexity score for the first subset of the training data;
generating a second optimized quantum complexity score for the second subset of the training data;
selecting the respective first weights according to the first optimized quantum complexity score;
selecting the respective second weights according to the second optimized quantum complexity score; and
training the combination model to predict new weights for respective predictions generated by the at least one classical machine learning model and the at least one quantum machine learning model on data.

8. The system of claim 1, wherein the respective first weights and the respective second weights are selected to minimize errors in respective predictions generated by the at least one classical machine learning model and the at least one quantum machine learning model to improve performance of the hybrid machine learning model.

9. The system of claim 1, wherein the respective first weights and the respective second weights are assigned to samples comprised in the training dataset or to features of the samples comprised in the training dataset.

10. A computer-implemented method, comprising:
training, by a system operatively coupled to a processor, by employing a training dataset, a hybrid machine learning model to generate predictions, wherein the hybrid machine learning model comprises at least one classical machine learning model and at least one quantum machine learning model, and wherein the training comprises:
assigning, by the system, via a combination model, respective first weights to a first subset of training data selected from the training dataset based upon a defined classical weighting criterion;
assigning, by the system, via the combination model, respective second weights to a second subset of training data selected from the training dataset based upon a defined quantum weighting criterion;
training, by the system, the at least one classical machine learning model by employing first training data selected from the first subset of the training data based on the respective first weights and a defined classical selection criterion; and
training, by the system, the at least one quantum machine learning model, via one or more quantum processors, by employing second training data selected from the second subset of the training data based on the respective second weights and a defined quantum selection criterion.

11. The computer-implemented method of claim 10, further comprising:
combining, by the system, respective predictions generated by the at least one classical machine learning model and the at least one quantum machine learning model to generate a final prediction.

12. The computer-implemented method of claim 10, wherein the training the hybrid machine learning model further comprises:
training, by the system, the at least one classical machine learning model on a training set comprised in the training dataset;
training, by the system, the combination model on a validation set comprised in the training dataset by employing error labels based on erroneous predictions generated by the at least one classical machine learning model based on the validation set comprised in the training dataset;
predicting, by the system, via the combination model, error probabilities indicative of the at least one classical machine learning model generating new erroneous predictions based on the training set comprised in the training dataset;
selecting, by the system, via the combination model, the respective first weights and the respective second weights based on the error probabilities; and
combining, by the system, via the combination model, respective predictions generated by the at least one classical machine learning model and the at least one quantum machine learning model based on a different validation set comprised in the training dataset and a test set, after the training of the hybrid machine learning model.

13. The computer-implemented method of claim 10, wherein the training the hybrid machine learning model further comprises:
iteratively updating, by the system, via the combination model, the respective first weights and the respective second weights based on respective accuracies of the respective predictions; and
retraining, by the system, the at least one classical machine learning model and the at least one quantum machine learning model based on the updating.

14. The computer-implemented method of claim 10, wherein the training the hybrid machine learning model further comprises:
training the at least one classical machine learning model on a training set comprised in the training dataset;
training, by the system, the combination model on a validation set comprised in the training dataset by employing error labels based on erroneous predictions generated by the at least one classical machine learning model based on the validation set comprised in the training dataset;
predicting, by the system, via the combination model, error probabilities indicative of the at least one classical machine learning model generating new erroneous predictions based on the training set comprised in the training dataset;
grouping, by the system, via the combination model, samples from the training set associated with the new erroneous predictions into at least one cluster; and
training, by the system, the at least one quantum machine learning model based on the at least one cluster.

15. The computer-implemented method of claim 10, wherein the training the hybrid machine learning model further comprises:
partitioning, by the system, the training dataset into two or more clusters;
training, by the system, the at least one classical machine learning model and the at least one quantum machine learning model on the two or more clusters;
generating, by the system, via the at least one classical machine learning model, respective first predictions on respective clusters of the two or more clusters;
generating, by the system, via the at least one quantum machine learning model, respective second predictions on the respective clusters of the two or more clusters;
assigning, by the system, respective first clusters of the two or more clusters to the at least one classical machine learning model based on the respective first predictions; and
assigning, by the system, respective second clusters of the two or more clusters to the at least one quantum machine learning model based on the respective second predictions.

16. The computer-implemented method of claim 10, wherein the training the hybrid machine learning model further comprises:
generating, by the system, a first optimized quantum complexity score for the first subset of the training data;
generating, by the system, a second optimized quantum complexity score for the second subset of the training data;
selecting, by the system, the respective first weights according to the first optimized quantum complexity score;
selecting, by the system, the respective second weights according to the second optimized quantum complexity score; and
training the combination model to predict new weights for respective predictions generated by the at least one classical machine learning model and the at least one quantum machine learning model on data.

17. The computer-implemented method of claim 10, wherein the respective first weights and the respective second weights are selected to minimize errors in respective predictions generated by the at least one classical machine learning model and the at least one quantum machine learning model to improve performance of the hybrid machine learning model.

18. A computer program product for identifying training data for quantum machine learning models, the computer program product comprising a computer readable storage medium having program instructions embodied therewith, the program instructions executable by a processor to cause the processor to:
train, by the processor, by employing a training dataset, a hybrid machine learning model to generate predictions, wherein the hybrid machine learning model comprises at least one classical machine learning model and at least one quantum machine learning model, and wherein training the hybrid machine learning model comprises:
assigning, by the processor, via a combination model, respective first weights to a first subset of training data selected from the training dataset based upon a defined classical weighting criterion;
assigning, by the processor, via the combination model, respective second weights to a second subset of training data selected from the training dataset based upon a defined quantum weighting criterion;
training, by the processor, the at least one classical machine learning model by employing first training data selected from the first subset of the training data based on the respective first weights and a defined classical selection criterion; and
training, by the processor, the at least one quantum machine learning model, via one or more quantum processors, by employing second training data selected from the second subset of the training data based on the respective second weights and a defined quantum selection criterion.

19. The computer program product of claim 18, wherein the program instructions are further executable by the processor to cause the processor to:
combine, by the processor, respective predictions generated by the at least one classical machine learning model and the at least one quantum machine learning model to generate a final prediction.

20. The computer program product of claim 18, wherein the respective first weights and the respective second weights are assigned to samples comprised in the training dataset or to features of the samples comprised in the training dataset.
